(19) United States
(12) Patent Application Publication
(10) Pub. No.: US 2025/0119908 A1
(43) Pub. Date: Apr. 10, 2025

(54) COMMUNICATION DEVICE AND COMMUNICATION METHOD

(71) Applicant: Sony Group Corporation, Tokyo (JP)

(72) Inventors: Takuma TAKADA, Tokyo (JP); Naoyuki TOYODA, Tokyo (JP); Masahiko IKEDA, Tokyo (JP); Yoshio KONNO, Tokyo (JP); Yojiro SHIMIZU, Tokyo (JP)

(73) Assignee: Sony Group Corporation, Tokyo (JP)

(21) Appl. No.: 18/833,030

(22) PCT Filed: Feb. 14, 2023
(86) PCT No.: PCT/JP2023/004885

§ 371 Date: Jul. 25, 2024

(30) Foreign Application Priority Data
Mar. 4, 2022 (JP) 2022-033432

(51) Int. Cl. H04W 72/1268; H04W 16/28; H04W 88/02

(52) U.S. Cl. CPC H04W 72/1268; H04W 16/28; H04W 88/02

(57) ABSTRACT

A communication device includes a transmission unit that, when priority of uplink data is predetermined priority, preferentially over an operation concerning mobility, transmits a buffer status report linked with the uplink data to a base station and a reception unit that receives, from the base station, an uplink scheduling grant corresponding to the buffer status report.

### FIELD

The present disclosure relates to a communication device and a communication method.

### BACKGROUND

In recent years, in cellular wireless communication, development for reduction of a delay in data transmission has been actively performed. For example, Patent Literature 1 discloses a method of realizing a reduction in a delay of data transmission by prioritizing transmission of a buffer status report (BSR) concerning data for URLLC (Ultra-Reliable and Low Latency Communications) over transmission of a BSR concerning data for eMBB (enhanced Mobile BroadBand).

### CITATION LIST

### Patent Literature

Patent Literature 1: WO 2020/161778 A

### SUMMARY

### Technical Problem

In recent years, services requiring a low delay, such as video streaming distribution and cloud games, have been increasing. However, there is a possibility that low delay required in such a service is not realized only by the delay reduction technique of the related art. For example, at timing when a terminal device performs an operation concerning mobility (for example, a measurement operation for a frequency other than a frequency of a serving cell), the transmission of the BSR is canceled regardless of whether the transmission of the BSR is transmission of a BSR concerning the data for the URLLC or transmission of the BSR concerning the data for the eMBB data. In this case, allocation of an uplink scheduling grant corresponding to the BSR is delayed and transmission of uplink data is delayed.

Therefore, the present disclosure proposes a communication device and a communication method capable of realizing low-delay communication.

Note that the problem or the object described above is merely one of a plurality of problems or objects that can be solved or achieved by a plurality of embodiments disclosed in the present specification.

### Solution to Problem

In order to solve the above problem, a communication device according to one embodiment of the present disclosure includes: a transmission unit that, when priority of uplink data is predetermined priority, preferentially over an operation concerning mobility, transmits a buffer status report linked with the uplink data to a base station; and a reception unit that receives, from the base station, an uplink scheduling grant corresponding to the buffer status report.

### BRIEF DESCRIPTION OF DRAWINGS

FIG. 1 is a sequence chart illustrating a UL data transmission procedure of the related art.

FIG. 2 is a diagram illustrating a state in which a transmission delay of UL data has occurred.

FIG. 3 is a diagram illustrating a configuration example of a communication system according to an embodiment of the present disclosure.

FIG. 4 is a diagram illustrating a configuration example of a server according to the embodiment of the present disclosure.

FIG. 5 is a diagram illustrating a configuration example of a management device according to the embodiment of the present disclosure.

FIG. 6 is a diagram illustrating a configuration example of a base station according to the embodiment of the present disclosure.

FIG. 7 is a diagram illustrating a configuration example of a terminal device according to the embodiment of the present disclosure.

FIG. 8 is a diagram illustrating an example of a use case of the communication system.

FIG. 9 is a diagram illustrating another example of a use case of the communication system.

FIG. 10 is a diagram illustrating a BSR transmission operation of the related art.

FIG. 11 is a diagram illustrating a BSR transmission operation of in a first embodiment.

FIG. 12 is a diagram illustrating a specific example of priority setting to UL data.

FIG. 13 is a diagram illustrating a modification of the BSR transmission operation in the first embodiment.

FIG. 14 is a sequence chart illustrating a UL data transmission procedure in a second embodiment.

FIG. 15 is a sequence chart illustrating a UL data transmission procedure in a third embodiment.

### DESCRIPTION OF EMBODIMENTS

Embodiments of the present disclosure are explained in detail below with reference to the drawings. Note that, in the embodiments explained below, redundant explanation is omitted by denoting the same parts with the same reference numerals and signs.

In the present specification and the drawings, a plurality of components having substantially the same functional configuration may be distinguished by adding different numbers after the same reference signs. For example, a plurality of components having substantially the same functional configuration are distinguished as terminal devices 40₁, 40₂, and 40₃ according to necessity. However, when it is not particularly necessary to distinguish each of a plurality of components having substantially the same functional configuration, only the same reference numeral is added. For example, when it is unnecessary to particularly distinguish the terminal devices 40₁, 40₂, and 40₃, the terminal devices 40₁, 40₂, and 40₃ are simply referred to as terminal devices 40.

One or a plurality of embodiments (including examples and modifications) explained below can be respectively independently implemented. On the other hand, at least a part of the plurality of embodiments explained below may be implemented in combination with at least a part of other embodiments as appropriate. These plurality of embodiments can include new characteristics different from one another. Therefore, these plurality of embodiments can contribute to solving objects or problems different from one another and can achieve effects different from one another.

### 1. Overview

Radio access technologies (RATs) such as LTE (Long Term Evolution) and NR (New Radio) have been studied in the 3GPP (3rd Generation Partnership Project). The LTE and the NR are types of a cellular communication technology and enable mobile communication of a terminal device by arranging a plurality of areas covered by a base station in a cell shape. At this time, a single base station may manage a plurality of cells.

Note that, in the following explanation, it is assumed that “LTE” includes LTE-A (LTE-Advanced), LTE-A Pro (LTE-Advanced Pro), and EUTRA (Evolved Universal Terrestrial Radio Access). The NR includes NRAT (New Radio Access Technology) and FEUTRA (Further EUTRA). In the following explanation, a cell adapted to the LTE is referred to as LTE cell and a cell adapted to the NR is referred to as NR cell.

The NR is a next generation (fifth generation) radio access technology (RAT) of the LTE. The NR is a radio access technology that can cope with various use cases including eMBB (Enhanced Mobile Broadband), mMTC (Massive Machine Type Communications), and URLLC (Ultra-Reliable Low Latency Communications). In NR, various technologies have been introduced aiming at a technical framework corresponding to usage scenarios, requirement conditions, arrangement scenarios, and the like in these use cases. For example, in the NR, in order to cope with diversification of communication services, new technologies such as a BWP (Band Width Part) and a network slice have been introduced.

### 1-1. UL Data Transmission Procedure of the Related Art

Before describing problems and an overview of solutions of the present embodiment, a procedure until the terminal device starts transmitting uplink data is explained below.

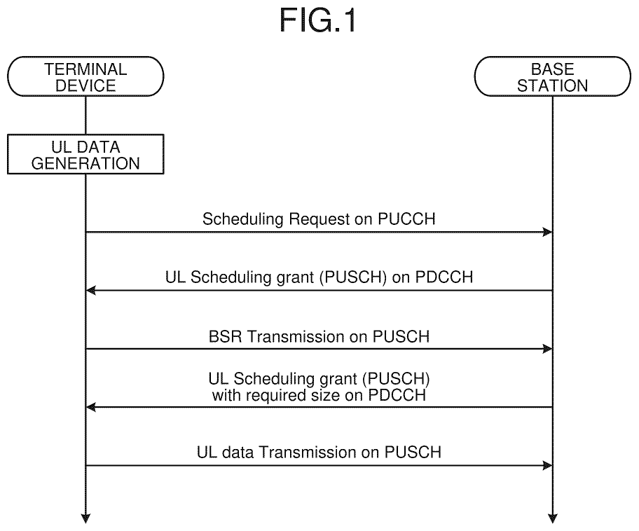

FIG. 1 is a sequence chart illustrating a UL data transmission procedure of the related art. In the following explanation, uplink is sometimes referred to as a UL. In the following explanation, downlink is sometimes referred to as DL.

First, when UL data is generated in the terminal device, the terminal device transmits a scheduling request (SR) to the base station through a PUCCH (Physical Uplink Control Channel).

After receiving the scheduling request, the base station determines a UL scheduling grant. Then, the base station notifies the UL scheduling grant to the terminal device through a PDCCH (Physical Downlink Control Channel). The UL scheduling grant includes information (for example, information concerning transmission timing, resource allocation, and a modulation scheme) concerning PUSCH (Physical Uplink Shared CHannel) resources for UL data transmission.

The terminal device transmits a buffer status report (BSR) to the base station. The BSR includes information concerning an amount of UL data present in a buffer of the terminal device. The terminal device transmits the BSR according to transmission timing and radio resource allocation determined by the UL scheduling grant.

The base station determines a UL scheduling grant having an appropriate size based on the BSR reported from the terminal device. Then, the base station notifies the UL scheduling grant to the terminal device through a PDCCH (Physical Downlink Control Channel).

The terminal device starts to transmit the UL data according to the instructed UL scheduling grant.

### 1-2. Problems and an Overview of Solutions of the Present Embodiment

Based on the above, problems and an overview of solutions of the present embodiment are explained.

In recent years, for example, services requiring low delay, such as video streaming distribution and cloud games, have been increasing. However, there is a possibility that low delay required in such a service is not realized only by the delay reduction technique of the related art. In the following explanation, specific examples of the problems of the present embodiment are explained.

### 1-2-1. Problem 1

In some case, transmission of a BSR (Buffer status report) is canceled/skipped on a UE side and transmission of UL data is delayed. For example, when timing when the terminal device performs an operation concerning mobility and timing when the terminal device transmits the BSR overlap, the transmission of the BSR is canceled/skipped on the terminal device side, and the transmission of the UL data is delayed. Specific examples of the operation concerning mobility include the following examples (1) to (2).

(1) Measurement Operation for a Frequency Other than a Frequency of a Serving Cell

A Measurement Gap is set in the terminal device. Here, the Measurement Gap means a measurement window for measuring frequencies (hereinafter also referred to as different frequencies) other than the frequency of the serving cell. The base station instructs a period and a time width in RRC (Radio Resource Control). During that period, the terminal device carries out the measurement of the different frequencies without transmitting and receiving data. For that reason, when measurement timing of the different frequencies and transmission timing of the BSR conflict, the terminal device cancels/skips the transmission of the BSR.

### (2) Beam Switching Operation and Handover

When the terminal device receives, in RRC Reconfiguration, an instruction of beam switching or an instruction of handover (HO) from the base station immediately before transmitting the BSR, the terminal device cancels/skips the transmission of the BSR.

When the transmission of the BSR is canceled/skipped, even if the UL data is present on the inside of the terminal device, the terminal device is not allocated with the UL scheduling grant from the base station. Alternatively, the allocation of the UL scheduling grant is delayed. As a result, a transmission delay of the UL data occurs.

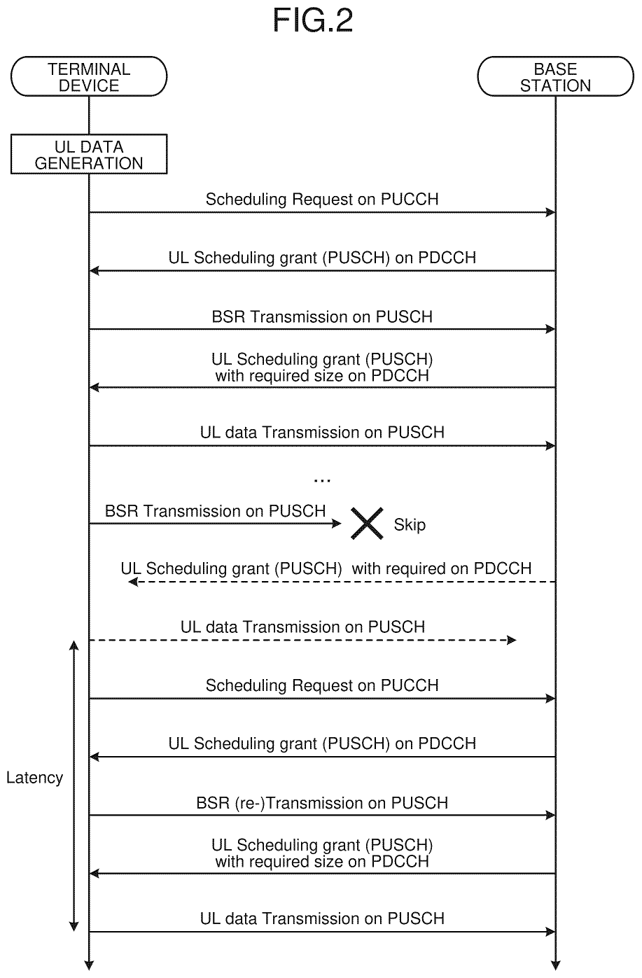

FIG. 2 is a diagram illustrating a state in which the transmission delay of the UL data has occurred. In an example illustrated in FIG. 2, the transmission of the BSR is skipped halfway in the sequence. In this case, the UL scheduling grant, which is supposed to be allocated, is not allocated and the terminal device cannot transmit the UL data. Then, the terminal device has to redo a transmission procedure from transmission of a scheduling request and the transmission of the UL data is delayed.

When the transmission delay of the UL data occurs, for example, an influence such as a video being stopped/delayed occurs in a service requiring a low delay such as video streaming distribution or a cloud game.

### 1-2-2. Problem 2

When it is known that UL transmission continuously occurs in video streaming distribution, a game, or the like, a procedure itself of transmitting a BSR (Buffer status report) and receiving a UL scheduling grant is redundant.

In particular, in a service in which UL data transmission continuously occurs such as video streaming distribution or a game, the buffer in the terminal device sometimes instantaneously has no UL data. At this time, when the terminal device reports a BSR indicating that the buffer has no UL data (hereinafter also referred to as BSR=0) to the base station, the allocation of the UL scheduling grant from the base station is stopped. Then, the terminal device has to redo a transmission procedure from transmission of a scheduling request regardless of the fact that a transmission demand of the UL data has been continuously generated. If a procedure until the UL scheduling grant is given is redundant, the transmission of the UL data is greatly delayed.

As a method in which the procedure until the UL scheduling grant is given is simplified, Semi-Persistent-Scheduling/Configured grant is prepared in the 3GPP. However, in these methods, a settable grant period is determined in advance. There is a possibility that these methods do not match the use case explained above.

### 1-3. Overview of Solutions

Therefore, in the present embodiment, the problems described above is solved by the following means.

### 1-3-1. Solution 1

The terminal device gives priority to UL data. For example, the communication device gives high priority to data of a service requiring a low delay, such as video streaming distribution or a cloud game, and gives normal priority to other data. Then, when the priority of the UL data is high, even at timing for performing an operation concerning mobility, the terminal device transmits a BSR (Buffer status report) linked with the UL data to the base station preferentially over the operation concerning mobility. Thereafter, when receiving a UL scheduling grant corresponding to the BSR from the base station, the terminal device transmits the UL data based on the UL scheduling grant.

### 1-3-2. Solution 2

In a predetermined state, the terminal device transmits a BSR (Buffer status report) to the base station through a PUCCH (Physical Uplink Control Channel) or an SRS (Sounding Reference Signal). For example, in the case of a state in which the BSR cannot be transmitted to the base station through a PUSCH (Physical Uplink Shared Channel) because of an operation concerning mobility, the terminal device transmits the BSR to the base station through the PUCCH or the SRS. Alternatively, in the case of a state in which UL data is continuously generated, the terminal device transmits the BSR to the base station through the PUCCH or the SRS. Thereafter, when receiving a UL scheduling grant corresponding to the BSR from the base station, the terminal device transmits the UL data based on the UL scheduling grant.

### 1-3-3. Solution 3

The base station discriminates whether the terminal device is in a state in which UL data is continuously generated. When it is discriminated that the base station is in the state in which UL data is continuously generated, the base station transmits a UL scheduling grant corresponding to the continuously generated UL data to the terminal device even when a BSR (Buffer status report) indicating that there is no UL data in the buffer is received from the terminal device or even when a BSR is not transmitted from the terminal device. The terminal device receives the UL scheduling grant corresponding to the continuously generated UL data from the base station. Then, the terminal device transmits the UL data based on the received UL scheduling grant.

### 1-3-4. Solution 4

Even when no UL data is left in the buffer, the terminal device transmits a BSR (Buffer status report) indicating that UL data is present in the buffer to the base station. Thereafter, when receiving a UL scheduling grant corresponding to the BSR from the base station, the terminal device transmits the UL data based on the UL scheduling grant.

With these means, the terminal device and the base station can realize low-delay communication.

### 2. Configuration of the Communication System

The overview of the present embodiment is explained above. Before the present embodiment is explained in detail, a configuration of the communication system 1 including an information processing device of the present embodiment is explained. Note that the communication system can be replaced as information processing system.

### 2-1. Configuration Example of the Communication System

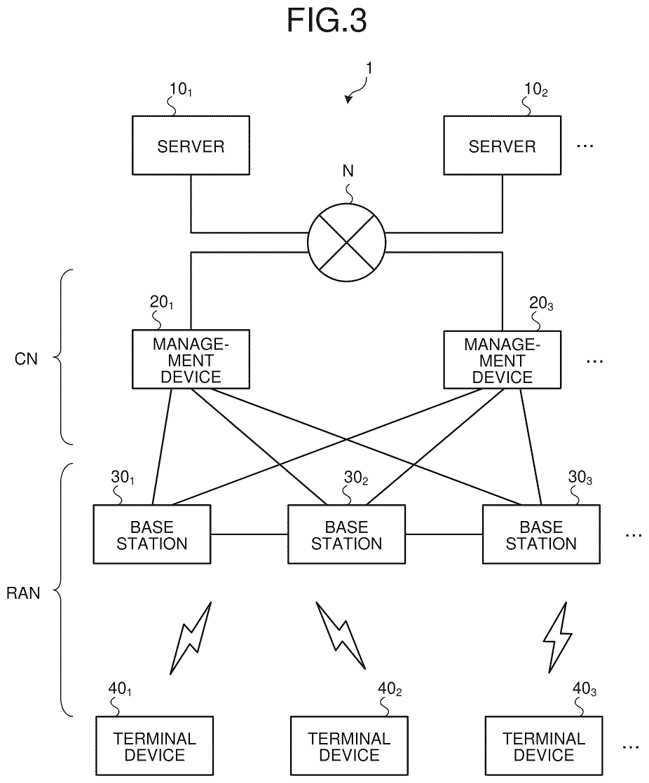

FIG. 3 is a diagram illustrating a configuration example of the communication system 1 according to the embodiment of the present disclosure. The communication system 1 includes a server 10, a management device 20, a base station 30, and a terminal device 40. Wireless communication devices configuring the communication system 1 operate in cooperation, whereby the communication system 1 provides, to a user, a radio network capable of performing mobile communication. A radio network in the present embodiment is configured by, for example, a radio access network and a core network. Note that, in the present embodiment, the wireless communication devices mean devices having a function of wireless communication. In the example illustrated in FIG. 3, the base station 30 and the terminal device 40 correspond to the wireless communication devices.

The communication system 1 may include a plurality of servers 10, a plurality of management devices 20, a plurality of base stations 30, and a plurality of terminal devices 40. In the example illustrated in FIG. 3, the communication system 1 includes servers 10₁ and 10₂ as the servers 10, includes management devices 20₁ and 20₂ as the management devices 20, includes base stations 30₁, 30₂, and 30₃ as the base stations 30, and includes terminal devices 40₁, 40₂, and 40₃ as the terminal devices 40.

In the example illustrated in FIG. 3, the servers 10 and the management devices 20 are connected via a network N. The network N is a communication network such as a LAN (Local Area Network), a WAN (Wide Area Network), a telephone network (a mobile telephone network, a fixed telephone network, or the like), a regional IP (Internet Protocol) network, or the Internet. The network N may include a wired network or may include a radio network. The network N may include a core network. The core network is, for example, an EPC (Evolved Packet Core) or a 5GC (5G Core network). Naturally, the network N may be a data network connected to the core network.

Note that the devices in the figure may be considered devices in a logical sense. That is, a part of the devices in the figure may be implemented by a virtual machine (VM), a container, a docker, and the like and may be implemented on physically the same hardware.

Note that the communication system 1 may support a radio access technology (RAT) such as LTE (Long Term Evolution) and NR (New Radio). The LTE and the NR are types of a cellular communication technology and enable mobile communication of a terminal device by arranging a plurality of areas covered by a base station in a cell shape. Note that a radio access scheme used by the communication system 1 is not limited to the LTE and the NR and may be another radio access scheme such as W-CDMA (Wideband Code Division Multiple Access) or cdma2000 (Code Division Multiple Access 2000).

A base station or a relay station configuring the communication system 1 may be a ground station or may be a non-ground station. The non-ground station may be a satellite station or may be an aircraft station. If the non-ground station is the satellite station, the communication system 1 may be a Bent-pipe (Transparent) type mobile satellite communication system.

Note that, in the present embodiment, the ground station (also referred to as ground base station) refers to a base station (including a relay station) installed on the ground. Here, the “ground” is a ground in a broad sense including not only the land but also underground, on water, and underwater. Note that, in the following explanation, the description of “ground station” may be replaced with “gateway”.

Note that an LTE base station is sometimes referred to as eNodeB (Evolved Node B) or eNB. An NR base station is sometimes referred to as gNodeB or gNB. In the LTE and the NR, the terminal device (also referred to as mobile station or terminal) is sometimes referred to as UE (User Equipment). Note that the terminal device is a type of a communication device and is also referred to as mobile station or terminal.

In the present embodiment, the concept of the communication device includes not only a portable mobile body device (terminal device) such as a portable terminal but also a device installed in a structure or a mobile body. The structure or the mobile body itself may be regarded as the communication device. The concept of the communication device includes not only the terminal device but also the base station and the relay station. The communication device is a type of a processing device and an information processing device. The communication device can be replaced as transmission device or reception device.

In the following explanation, configurations of the devices configuring the communication system 1 are specifically explained. Note that the configurations of the devices explained below are merely an example. The configurations of the devices may be different from the configurations explained below.

### 2-2. Configuration of the Server

First, a configuration of the server 10 is explained.

The server 10 is an information processing device (a computer) that provides various services to the terminal device 40. For example, the server 10 is an information processing device that executes processing concerning a service requiring a low delay, such as video streaming distribution or a cloud game. The server 10 may be a PC server, may be a midrange server, or may be a mainframe server.

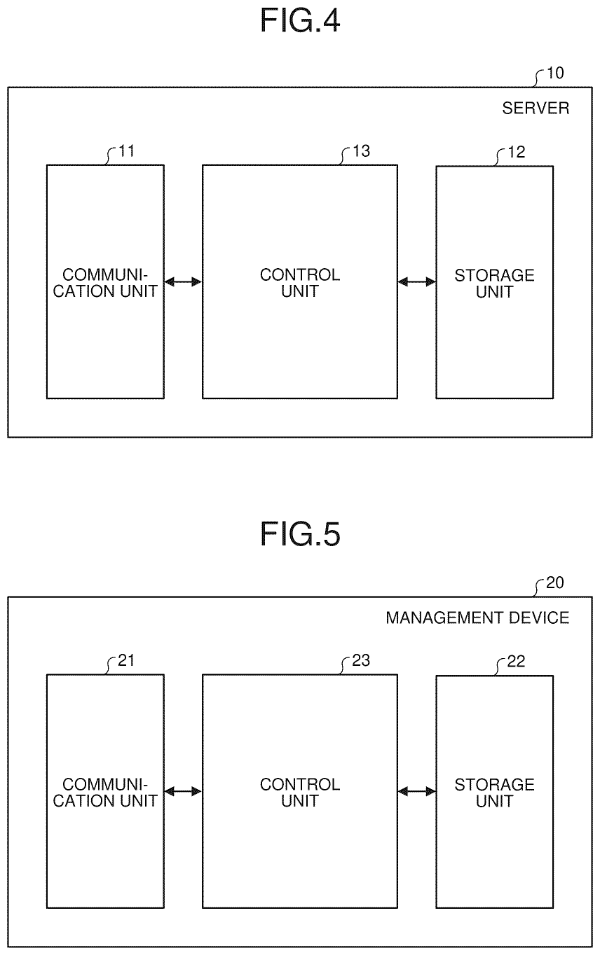

FIG. 4 is a diagram illustrating a configuration example of the server 10 according to the embodiment of the present disclosure. The server 10 includes a communication unit 11, a storage unit 12, and a control unit 13. Note that the configuration illustrated in FIG. 4 is a functional configuration. A hardware configuration may be different from this configuration. The functions of the server 10 may be implemented to be distributed to a plurality of physically separated components. For example, the server 10 may be configured by a plurality of server devices.

The communication unit 11 is a communication interface for communicating with other devices. The communication unit 11 may be a network interface or may be an equipment connection interface. For example, the communication unit 11 may be a LAN (Local Area Network) interface such as an NIC (Network Interface Card) or may be a USB interface configured by a USB (Universal Serial Bus) host controller, a USB port, and the like. The communication unit 11 may be a wired interface or may be a wireless interface. The communication unit 11 functions as communication means of the server 10. The communication unit 11 communicates with the base station 30 according to control of the control unit 13.

The storage unit 12 is a data readable/writable storage device such as a DRAM (Dynamic Random Access Memory), an SRAM (Static Random Access Memory), a flash memory, or a hard disk. The storage unit 12 functions as storage means of the server 10. The storage unit 12 stores, for example, cloud game operation information and streaming data transmitted from the terminal device 40 via the base station 30.

The control unit 13 is a controller that controls the units of the server 10. The control unit 13 is implemented by a processor such as a CPU (Central Processing Unit) or an MPU (Micro Processing Unit). For example, the control unit 13 is implemented by the processor executing various programs stored in a storage device inside the server 10 using a RAM (Random Access Memory) or the like as a work area. Note that the control unit 13 may be implemented by an integrated circuit such as an ASIC (Application Specific Integrated Circuit) or an FPGA (Field Programmable Gate Array). All of the CPU, the MPU, the ASIC, and the FPGA can be regarded as the controller.

### 2-3. Configuration Example of the Management Device

Subsequently, a configuration of the management device 20 is explained.

The management device 20 is an information processing device (a computer) that manages a radio network. For example, the management device 20 is an information processing device that manages communication of the base station 30. The management device 20 may be, for example, a device having a function of an MME (Mobility Management Entity). The management device 20 may be a device having a function of an AMF (Access and Mobility Management Function) and/or an SMF (Session Management Function). Of course, the functions of the management device 20 are not limited to the MME, the AMF, and the SMF. The management device 20 may be a device having a function of an NSSF (Network Slice Selection Function), an AUSF (Authentication Server Function), a PCF (Policy Control Function), or a UDM (Unified Data Management). Furthermore, the management device 20 may be a device having a function of an HSS (Home Subscriber Server).

Note that the management device 20 may have a function of a gateway. For example, the management device 20 may have a function of an S-GW (Serving Gateway) or a P-GW (Packet Data Network Gateway). The management device 20 may have a function of a UPF (User Plane Function). At this time, the management device 20 may have a plurality of UPFs. The plurality of UPFs may respectively function as UPF resources of different network slices.

The core network is configured from a plurality of network functions. The network functions may be aggregated into one physical device or may be distributed to a plurality of physical devices. That is, the management device 20 can be distributed and disposed in a plurality of devices. Further, this distributed disposition may be controlled to be dynamically executed. The base station 30 and the management device 20 configure one network and provide a wireless communication service to the terminal device 40. The management device 20 is connected to the Internet. The terminal device 40 can use, via the base station 30, various services provided via the Internet.

Note that the management device 20 may not always be a device configuring the core network. For example, it is assumed that the core network is a core network of W-CDMA (Wideband Code Division Multiple Access) or cdma2000 (Code Division Multiple Access 2000). At this time, the management device 20 may be a device that functions as an RNC (Radio Network Controller).

FIG. 5 is a diagram illustrating a configuration example of the management device 20 according to the embodiment of the present disclosure. The management device 20 includes a communication unit 21, a storage unit 22, and a control unit 23. Note that the configuration illustrated in FIG. 5 is a functional configuration. A hardware configuration may be different from this configuration. The functions of the management device 20 may be statically or dynamically distributed and implemented in a plurality of physically separated components. For example, the management device 20 may be configured by a plurality of server devices.

The communication unit 21 is a communication interface for communicating with other devices. The communication unit 21 may be a network interface or may be an equipment connection interface. For example, the communication unit 21 may be a LAN (Local Area Network) interface such as an NIC (Network Interface Card) or may be a USB interface configured by a USB (Universal Serial Bus) host controller, a USB port, and the like. The communication unit 21 may be a wired interface or may be a wireless interface. The communication unit 21 functions as communication means of the management device 20. The communication unit 21 communicates with the base station 30 and the like according to control of the control unit 23.

The storage unit 22 is a data readable/writable storage device such as a DRAM (Dynamic Random Access Memory), an SRAM (Static Random Access Memory), a flash memory, or a hard disk. The storage unit 22 functions as storage means of the management device 20. The storage unit 22 stores, for example, a connection state of the terminal device 40. For example, the storage unit 22 stores a state of RRC (Radio Resource Control) or a state of ECM (EPS Connection Management) or 5G System CM (Connection Management) of the terminal device 40. The storage unit 22 may function as a home memory that stores position information of the terminal device 40.

The control unit 23 is a controller that controls the units of the management device 20. The control unit 23 is implemented by a processor such as a CPU (Central Processing Unit), an MPU (Micro Processing Unit), or a GPU (Graphics Processing Unit) For example, the control unit 23 is implemented by the processor executing various programs stored in a storage device inside the management device 20 using a RAM (Random Access Memory) or the like as a work area. Note that the control unit 23 may be realized by an integrated circuit such as an ASIC (Application Specific Integrated Circuit) or an FPGA (Field Programmable Gate Array). All of the CPU, the MPU, the GPU, the ASIC, and the FPGA can be regarded as the controller.

### 2-4. Configuration Example of the Base Station

Subsequently, a configuration of the base station 30 is explained.

The base station 30 is a wireless communication device that performs wireless communication with the terminal device 40. The base station 30 may be configured to wirelessly communicate with the terminal device 40 via the relay station or may be configured to directly wirelessly communicate with the terminal device 40.

The base station 30 is a type of a communication device. More specifically, the base station 30 is a device equivalent to a radio base station (a base Station, a Node B, eNB, gNB, or the like) or a radio access point. The base station 30 may be a wireless relay station. The base station 30 may be an optical extension device called RRH (Remote Radio Head) or RU (Radio Unit). The base station 30 may be a receiving station such as an FPU (Field Pickup Unit). The base station 30 may be an IAB (Integrated Access and Backhaul) donor node or an IAB relay node that provides a radio access line and a radio backhaul line with time division multiplexing, frequency division multiplexing, or space division multiplexing.

Note that a radio access technology used by the base station 30 may be a cellular communication technology or may be a wireless LAN technology. Naturally, the radio access technology used by the base station 30 is not limited the above and may be another radio access technology. For example, the radio access technology used by the base station 30 may be an LPWA (Low Power Wide Area) communication technology. Naturally, wireless communication used by the base station 30 may be wireless communication using millimeter waves. The wireless communication used by the base station 30 may be wireless communication using radio waves or wireless communication (optical wireless) using infrared rays or visible light. The base station 30 may be capable of performing NOMA (Non-Orthogonal Multiple Access) communication with the terminal device 40. Here, the NOMA communication is communication (transmission, reception, or both of transmission and reception) using non-orthogonal resources. Note that the base station 30 may be capable of performing the NOMA communication with the other base stations 30.

Note that the base stations 30 may be capable of communicating with one another via a base station-core network interface (for example, an NG Interface or an S1 Interface). This interface may be either wired or wireless. The base stations may be capable of communicating with one another via an inter-base station interface (for example, an Xn Interface, an X2 Interface, an S1 Interface, an F1 Interface, or the like). This interface may be either wired or wireless.

Note that the concept of the base station includes not only a donor base station but also a relay base station (also referred to as relay station.). For example, the relay base station may be any one of RF Repeater, Smart Repeater, and Intelligent Surface. The concept of the base station includes not only a structure having a function of the base station but also a device installed in the structure.

The structure is a building such as a high-rise building, a house, a steel tower, a station facility, an airport facility, a harbor facility, an office building, a school building, a hospital, a factory, a commercial facility, or a stadium. Note that the concept of the structure includes not only a building but also a structure (a non-building structure) such as a tunnel, a bridge, a dam, a wall, or an iron pillar and equipment such as a crane, a gate, or a windmill. The concept of the structure includes not only a structure on the land (the ground in a narrow sense) or in the ground but also a structure on water such as a pier or a mega-float and a structure under water such as marine observation equipment. The base station can be replaced as information processing device.

The base station 30 may be a donor station or may be a relay station. The base station 30 may be a fixed station or may be a mobile station. The mobile station is a wireless communication device (for example, a base station) configured to be movable. At this time, the base station 30 may be a device installed in a mobile body or may be the mobile body itself. For example, a relay station having mobility can be regarded as the base station 30 functioning as a mobile station. A device originally having mobility and implemented with a function of a base station (at least a part of the function of the base station) such as a vehicle, a UAV (Unmanned Aerial Vehicle) represented by a drone, or a smartphone also corresponds to the base station 30 functioning as the mobile station.

Here, the mobile body may be a mobile terminal such as a smartphone or a cellular phone. The mobile body may be a mobile body (for example, a vehicle such as an automobile, a bicycle, a bus, a truck, a motorcycle, a train, or a linear motor car) that moves on the land (the ground in a narrow sense) or a mobile body (for example, a subway) that moves in the ground (for example, in a tunnel). The mobile body may be a mobile body (for example, a ship such as a passenger ship, a cargo ship, or a hovercraft) that moves on water or a mobile body (for example, a submersible such as a submersible ship, a submarine, or an unmanned submersible) that moves under water. Note that the mobile body may be a mobile body (for example, an aircraft such as an airplane, an airship, or a drone) that moves in the atmosphere.

The base station 30 may be a ground base station (a ground station) installed on the ground. For example, the base station 30 may be a base station disposed in a structure on the ground or may be a base station installed in a mobile body moving on the ground. More specifically, the base station 30 may be an antenna installed in a structure such as a building and a signal processing device connected to the antenna. Naturally, the base station 30 may be the structure or the mobile body itself. “On the ground” is on the ground in a broad sense including not only on the land (on the ground in a narrow sense) but also underground, on water, and underwater. Note that the base station 30 is not limited to the ground base station. For example, when the communication system 1 is a satellite communication system, the base station 30 may be an aircraft station. From the perspective of a satellite station, an aircraft station located on the earth is a ground station.

Note that the base station 30 is not limited to the ground station. The base station 30 may be a non-ground base station (a non-ground station) capable of floating in the air or the space. For example, the base station 30 may be an aircraft station or a satellite station.

The satellite station is a satellite station capable of floating outside the atmosphere. The satellite station may be a device loaded on a space mobile body such as an artificial satellite or may be the space mobile body itself. The space mobile body is a mobile body that moves outside the atmosphere. Examples of the space mobile body include artificial celestial bodies such as an artificial satellite, a spacecraft, a space station, and a probe. Note that a satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. Naturally, the satellite station may be a device loaded on the low earth orbiting satellite, the middle earth orbiting satellite, the geostationary earth orbiting satellite, or the high elliptical orbiting satellite.

The aircraft station is a wireless communication device capable of floating in the atmosphere such as an aircraft. The aircraft station may be a device loaded on an aircraft or the like or may be the aircraft itself. Note that the concept of the aircraft includes not only a heavy aircraft such as an airplane and a glider but also a light aircraft such as a balloon and an airship. The concept of the aircraft includes not only the heavy aircraft and the light aircraft but also a rotorcraft such as a helicopter and an auto-gyroscope. Note that the aircraft station (or an aircraft on which the aircraft station is loaded) may be an unmanned aircraft such as a drone.

Note that the concept of the unmanned aircraft also includes an unmanned aircraft system (UAS) and a tethered UAS. The concept of the unmanned aircraft includes a Lighter than Air UAS (LTA) and a Heavier than Air UAS (HTA). Besides, the concept of the unmanned aircraft also includes High Altitude UAS Platforms (HAPs).

The size of the coverage of the base station 30 may be a large size such as a macro cell or a small size such as a pico cell. Naturally, the size of the coverage of the base station 30 may be an extremely small size such as a femtocell. The base station 30 may have a beamforming capability. In this case, a cell or a service area may be formed in the base station 30 for each beam.

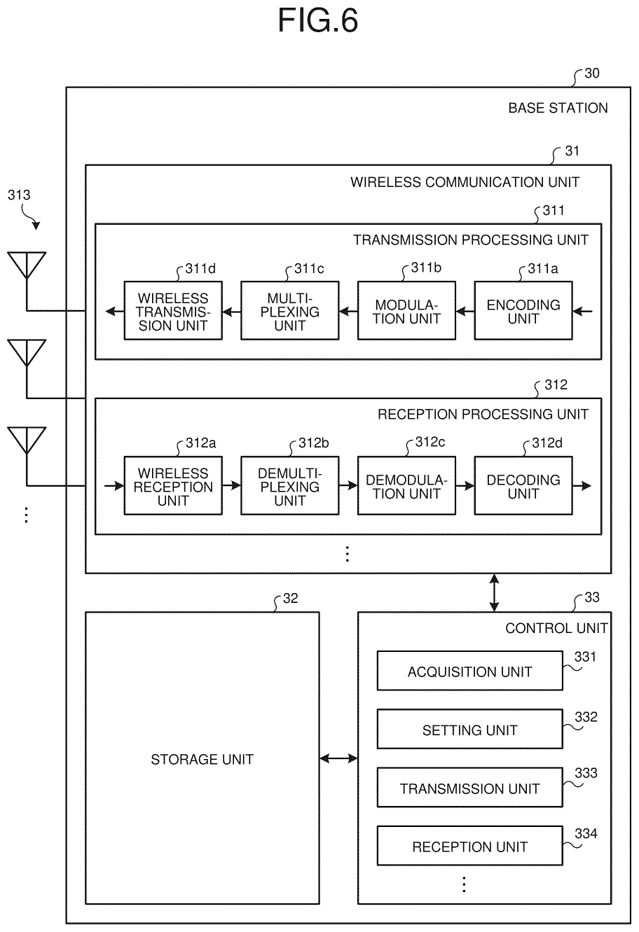

FIG. 6 is a diagram illustrating a configuration example of the base station 30 according to the embodiment of the present disclosure. The base station 30 includes a wireless communication unit 31, a storage unit 32, and a control unit 33. Note that the component illustrated in FIG. 6 is a functional configuration. A hardware configuration may be different from this configuration. The functions of the base station 30 may be distributed and implemented in a plurality of physically separated components.

The wireless communication unit 31 is a signal processing unit for wirelessly communicating with other wireless communication devices (for example, the terminal devices 40). The wireless communication unit 31 operates according to control of the control unit 33. The wireless communication unit 31 is adapted to one or a plurality of radio access schemes. For example, the wireless communication unit 31 is adapted to both of the NR and the LTE. The wireless communication unit 31 may be adapted to W-CDMA or cdma2000 in addition to the NR or the LTE. The wireless communication unit 31 may be adapted to an automatic retransmission technology such as HARQ (Hybrid Automatic Repeat reQuest).

The wireless communication unit 31 includes a transmission processing unit 311, a reception processing unit 312, and an antenna 313. The wireless communication unit 31 may include a plurality of transmission processing units 311, a plurality of reception processing units 312, and a plurality of antennas 313. Note that, when the wireless communication unit 31 is adapted to a plurality of radio access schemes, the units of the wireless communication unit 31 can be configured individually for each of the radio access schemes. For example, the transmission processing unit 311 and the reception processing unit 312 may be individually configured by the LTE and the NR. The antenna 313 may be configured by a plurality of antenna elements (for example, a plurality of patch antennas). In this case, the wireless communication unit 31 may be configured to be capable of performing beamforming. The wireless communication unit 31 may be configured to be capable of performing polarization beamforming using vertically polarized waves (V-polarized waves) and horizontally polarized waves (H-polarized waves).

The transmission processing unit 311 performs transmission processing for downlink control information and downlink data. For example, the transmission processing unit 311 encodes downlink control information and downlink data input from the control unit 33 using an encoding scheme such as block encoding, convolutional encoding, or turbo encoding. Here, as the encoding, encoding by a polar code or encoding by an LDPC code (Low Density Parity Check Code) may be performed. Then, the transmission processing unit 311 modulates encoded bits with a predetermined modulation scheme such as BPSK, QPSK, 16QAM, 64QAM, or 256QAM. In this case, signal points on a constellation do not always need to be equidistant from one another. The constellation may be a nonuniform constellation (NUC). Then, the transmission processing unit 311 multiplexes modulation symbols and downlink reference signals of channels and arranges the modulation symbols and the downlink reference signals in a predetermined resource element. Then, the transmission processing unit 311 performs various kinds of signal processing on multiplexed signals. For example, the transmission processing unit 311 performs processing such as conversion into a frequency domain by fast Fourier transform, addition of a guard interval (cyclic prefix), generation of a baseband digital signal, conversion into an analog signal, quadrature modulation, up-conversion, removal of an extra frequency component, and amplification of power. A signal generated by the transmission processing unit 311 is transmitted from the antenna 313.

The reception processing unit 312 processes an uplink signal received via the antenna 313. For example, the reception processing unit 312 performs, on the uplink signal, down-conversion, removal of an unnecessary frequency component, control of an amplification level, quadrature demodulation, conversion into a digital signal, removal of a guard interval (cyclic prefix), extraction of a frequency domain signal by fast Fourier transform, and the like. Then, the reception processing unit 312 separates uplink channels such as a PUSCH (Physical Uplink Shared Channel) and a PUCCH (Physical Uplink Control Channel) and an uplink reference signal from the signals subjected to these kinds of processing. The reception processing unit 312 performs, on a modulation symbol of the uplink channel, demodulation of the received signal using a modulation scheme such as BPSK (Binary Phase Shift Keying) or QPSK (Quadrature Phase Shift Keying). The modulation scheme used for the demodulation may be 16QAM (Quadrature Amplitude Modulation), 64QAM, or 256QAM. In this case, signal points on a constellation do not always need to be equidistant from one another. The constellation may be a non-uniform constellation (NUC). The reception processing unit 312 performs decoding processing on encoded bits of the demodulated uplink channel. Decoded uplink data and uplink control information are output to the control unit 33.

The antenna 313 is an antenna device (an antenna unit) that mutually converts a current and a radio wave. The antenna 313 may be configured by one antenna element (for example, one patch antenna) or may be configured by a plurality of antenna elements (for example, a plurality of patch antennas). When the antenna 313 is configured by a plurality of antenna elements, the wireless communication unit 31 may be configured to be capable of performing beamforming. For example, the wireless communication unit 31 may be configured to generate a directional beam by controlling the directivity of a radio signal using the plurality of antenna elements. Note that the antenna 313 may be a dual-polarized antenna. When the antenna 313 is the dual-polarized antenna, the wireless communication unit 31 may use vertically polarized waves (V-polarized waves) and horizontally polarized waves (H-polarized waves) in transmitting radio signals. Then, the wireless communication unit 31 may control the directivity of the radio signal transmitted using the vertically polarized wave and the horizontally polarized wave. The wireless communication unit 31 may transmit and receive spatially multiplexed signals via a plurality of layers configured by a plurality of antenna elements.

The storage unit 32 is a storage device capable of reading and writing data such as a DRAM, an SRAM, a flash memory, or a hard disk. The storage unit 32 functions as storage means of the base station 30.

The control unit 33 is a controller that controls the units of the base station 30. The control unit 33 is realized by a processor such as a CPU (Central Processing Unit) or an MPU (Micro Processing Unit). For example, the control unit 33 is implemented by the processor executing various programs stored in a storage device inside the base station 30 using a RAM (Random Access Memory) or the like as a work area. Note that the control unit 33 may be implemented by an integrated circuit such as an ASIC (Application Specific Integrated Circuit) or an FPGA (Field Programmable Gate Array). All of the CPU, the MPU, the ASIC, and the FPGA can be regarded as the controller. The control unit 33 may be implemented by a GPU (Graphics Processing Unit) in addition to or instead of the CPU.

The control unit 33 includes an acquisition unit 331, a setting unit 332, a transmission unit 333, and a reception unit 334. The blocks (the acquisition unit 331 to the reception unit 334) configuring the control unit 33 are respectively functional blocks indicating functions of the control unit 33. These functional blocks may be software blocks or may be hardware blocks. For example, each of the functional blocks explained above may be one software module implemented by software (including a microprogram) or may be one circuit block on a semiconductor chip (a die). Naturally, each of the functional blocks may be one processor or one integrated circuit. The control unit 33 may be configured by functional units different from the functional blocks explained above. A configuration method for the functional blocks is optional. Operations of the functional blocks are explained below.

In several embodiments, the concept of the base station may consist of a set of a plurality of physical or logical devices. For example, in this embodiment, the base station may be distinguished into a plurality of devices such as a BBU (Baseband Unit) and an RU (Radio Unit). Then, the base station may be interpreted as an aggregate of the plurality of devices. The base station may be one of the BBU and the RU or may be both of the BBU and the RU. The BBU and the RU may be connected by a predetermined interface (for example, eCPRI (enhanced Common Public Radio Interface)). Note that the RU may be replaced with RRU (Remote Radio Unit) or RD (Radio DoT). The RU may correspond to a gNB-DU (gNB Distributed Unit) explained below. Further, the BBU may correspond to a gNB-CU (gNB Central Unit) explained below. Alternatively, the RU may be a wireless device connected to a gNB-DU explained below. The gNB-CU, the gNB-DU, and the RU connected to the gNB-DU may be configured to conform to an O-RAN (Open Radio Access Network). Further, the RU may be a device formed integrally with an antenna. An antenna (for example, an antenna formed integrally with the RU) included in the base station may adopt an Advanced Antenna System and support MIMO (for example, FD-MIMO) or beamforming. The antenna included in the base station may include, for example, sixty-four transmission antenna ports and sixty-four reception antenna ports.

The antenna loaded in the RU may be an antenna panel configured from one or more antenna elements. The RU may be loaded with one or more antenna panels. For example, the RU may be loaded with two types of antenna panels including a horizontally polarized antenna panel and a vertically polarized antenna panel or two antenna panels including a clockwise circularly polarized antenna panel and a counterclockwise circularly polarized antenna panel. The RU may form and control an independent beam for each of the antenna panels.

Note that a plurality of base stations may be connected to one another. One or a plurality of base stations may be included in a radio access network (RAN). In this case, the base station is sometimes simply referred to as RAN, RAN node, AN (Access Network), or AN node. Note that a RAN in LTE is sometimes referred to as EUTRAN (Enhanced Universal Terrestrial RAN). A RAN in NR is sometimes referred to as NGRAN. A RAN in W-CDMA (UMTS) is sometimes referred to as UTRAN.

Note that an LTE base station is sometimes referred to as eNodeB (Evolved Node B) or eNB. At this time, the EUTRAN includes one or a plurality of eNodeBs (eNBs). An NR base station is sometimes referred to as gNodeB or gNB. At this time, the NGRAN includes one or a plurality of gNBs. The EUTRAN may include a gNB (en-gNB) connected to a core network (EPC) in an LTE communication system (EPS). Similarly, the NGRAN may include an ng-eNB connected to a core network 5GC in a 5G communication system (5GS).

Note that, when the base station is the eNB, the gNB, or the like, the base station is sometimes referred to as 3GPP access. When the base station is a radio access point, the base station is sometimes referred to as non-3GPP access. Further, the base station may be an optical extension device called RRH (Remote Radio Head) or RU (Radio Unit). When the base station is the gNB, the base station may be a combination of the gNB-CU and the gNB-DU explained above or may be one of the gNB-CU and the gNB-DU. Here, the gNB-CU hosts, for communication with the UE, a plurality of upper layers (for example, RRC (Radio Resource Control), SDAP (Service Data Adaptation Protocol), and PDCP (Packet Data Convergence Protocol)) in an access stratum. On the other hand, the gNB-DU hosts a plurality of lower layers (for example, RLC (Radio Link Control), MAC (Medium Access Control), and PHY (Physical layer)) in the access stratum. That is, among messages/information explained below, RRC signaling (a semi-static notification) may be generated by the gNB-CU and, on the other hand, MAC CE and DCI (a dynamic notification) may be generated by the gNB-DU. Alternatively, in the RRC configuration (a semi-static notification), for example, some configurations such as IE: cell group Config may be generated by the gNB-DU and the remaining configurations may be generated by the gNB-CU. These configurations may be transmitted and received by an F1 interface explained below.

Note that the base station may be configured to be capable of communicating with other base stations. For example, when a plurality of base stations are a combination of eNBs or eNBs and en-gNBs, the base stations may be connected by an X2 interface. When the plurality of base stations are the combination of the gNBs or the gn-eNBs and the gNBs, the devices may be connected by an Xn interface. When the plurality of base stations are a combination of gNB-CUs and gNB-DUs, the devices may be connected by the F1 interface explained above. A message/information (for example, RRC signaling, a MAC CE (MAC Control Element), or a DCI) explained below may be transmitted among a plurality of base stations, for example, via the X2 interface, the Xn interface, or the F1 interface.

Cells provided by the base station are sometimes referred to as serving cells. The concept of the serving cells includes a PCell (Primary Cell) and an SCell (Secondary Cell). When dual connectivity is configured in the UE (for example, the terminal device 40), a PCell and zero or one or more SCells provided by an MN (Master Node) are sometimes referred to as master cell group. Examples of the dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

Note that the serving cells may include a PSCell (Primary Secondary Cell or Primary SCG Cell). When the dual connectivity is set for the UE, a PSCell and zero or one or more SCells provided by an SN (Secondary Node) are sometimes referred to as SCG (Secondary Cell Group). Unless specific setting (for example, PUCCH on SCell) is performed, the physical uplink control channel (PUCCH) is transmitted by the PCell and the PSCell but is not transmitted by the SCell. A radio link failure is also detected by the PCell and the PSCell but is not detected (may not be detected) by the SCell. As explained above, since the PCell and the PSCell have a special role among the serving cells, the PCell and the PSCell are referred to as SpCell (Special Cell) as well.

One downlink component carrier and one uplink component carrier may be associated with one cell. A system bandwidth corresponding to one cell may be divided into a plurality of BWPs (Bandwidth Parts). In this case, one or a plurality of BWPs may be set for the UE and one BWP may be used for the UE as an active BWP. Radio resources (for example, a frequency band, numerology (subcarrier spacing), and a slot format (a Slot configuration)) that can be used by the terminal device 40 may be different for each of the cells, each of the component carriers, or each of the BWPs.

### 2-5. Configuration Example of the Terminal Device

Subsequently, a configuration of the terminal device 40 is explained. The terminal device 40 can be replaced as UE (User Equipment) 40.

The terminal device 40 is a wireless communication device that wirelessly communicates with other communication devices such as the base station 30. The terminal device 40 is, for example, a mobile phone, a smart device (a smartphone or a tablet terminal), a PDA (Personal Digital Assistant), or a personal computer. The terminal device 40 may be equipment such as a camera for business use including a communication function or may be a motorcycle, a mobile relay vehicle, or the like on which communication equipment such as an FPU (Field Pickup Unit) is loaded. The terminal device 40 may be an M2M (Machine to Machine) device or an IoT (Internet of Things) device.

Note that the terminal device 40 may be capable of performing NOMA communication with the base station 30. The terminal device 40 may be capable of using an automatic retransmission technology such as HARQ when communicating with the base station 30. The terminal device 40 may be capable of performing side-link communication with another terminal device 40. The terminal device 40 may also be capable of using the automatic retransmission technology such as HARQ when performing the side-link communication. Note that the terminal device 40 may be capable of performing NOMA communication in communication (side-link) with the other terminal devices 40. The terminal device 40 may be capable of performing LPWA communication with other communication devices (for example, the base station 30 and the other terminal devices 40). The wireless communication used by the terminal device 40 may be wireless communication using millimeter waves. Note that the wireless communication (including the side-link communication) used by the terminal device 40 may be wireless communication using radio waves or may be wireless communication (optical wireless) using infrared rays or visible light.

The terminal device 40 may be a mobile body device. The mobile body device is a movable wireless communication device. At this time, the terminal device 40 may be a wireless communication device installed in a mobile body or may be the mobile body itself. For example, the terminal device 40 may be a vehicle that moves on a road such as an automobile, a bus, a truck, or a motorcycle, a vehicle that moves on a rail installed on a track of a train or the like, or a wireless communication device loaded on the vehicle. Note that the mobile body may be a mobile terminal or may be a mobile body that moves on the land (on the ground in a narrow sense), underground, on water, or underwater. The mobile body may be a mobile body that moves inside the atmosphere such as a drone or a helicopter or may be a mobile body that moves outside the atmosphere such as an artificial satellite.

The terminal device 40 may be simultaneously connected to a plurality of base stations or a plurality of cells to implement communication. For example, when one base station supports a communication area via a plurality of cells (for example, pCells and sCells), the plurality of cells can be bundled to perform communication between the base station 30 and the terminal device 40 by a carrier aggregation (CA) technology, a dual connectivity (DC) technology, or a multi-connectivity (MC) technology. Alternatively, via cells of different base stations 30, with a coordinated multi-point transmission and reception (COMP) technology, the terminal device 40 and those plurality of base stations 30 can communicate.

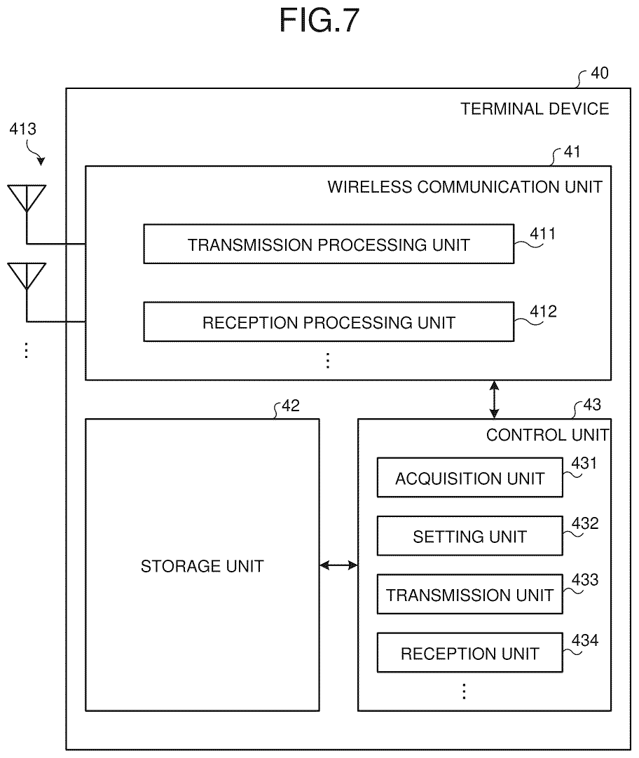

FIG. 7 is a diagram illustrating a configuration example of the terminal device 40 according to the embodiment of the present disclosure. The terminal device 40 includes a wireless communication unit 41, a storage unit 42, and a control unit 43. Note that the configuration illustrated in FIG. 7 is a functional configuration and a hardware configuration may be different from this configuration. The functions of the terminal device 40 may be distributed and implemented in a plurality of physically separated components.

The wireless communication unit 41 is a signal processing unit for wirelessly communicating with other wireless communication devices (for example, the base station 30 and the other terminal devices 40). The wireless communication unit 41 operates according to control of the control unit 43. The wireless communication unit 41 includes a transmission processing unit 411, a reception processing unit 412, and an antenna 413. Configurations of the wireless communication unit 41, the transmission processing unit 411, the reception processing unit 412, and the antenna 413 may be the same as the configurations of the wireless communication unit 31, the transmission processing unit 311, the reception processing unit 312, and the antenna 313 of the base station 30. The wireless communication unit 41 may be configured to be capable of performing beamforming like the wireless communication unit 31. Further, like the wireless communication unit 31, the wireless communication unit 41 may be configured to be capable of transmitting and receiving spatially multiplexed signals.

The storage unit 42 is a data readable/writable storage device such as a DRAM, an SRAM, a flash memory, or a hard disk. The storage unit 42 functions as storage means of the terminal device 40.

The control unit 43 is a controller that controls the units of the terminal device 40. The control unit 43 is realized by a processor such as a CPU or an MPU. For example, the control unit 43 is realized by the processor executing various programs stored in a storage device inside the terminal device 40 using a RAM or the like as a work area. Note that the control unit 43 may be realized by an integrated circuit such as an ASIC or an FPGA. All of the CPU, the MPU, the ASIC, and the FPGA can be regarded as the controller. The control unit 43 may be implemented by a GPU in addition to or instead of the CPU.

The control unit 43 includes an acquisition unit 431, a setting unit 432, a transmission unit 433, and a reception unit 434. The blocks (the acquisition unit 431 to the reception unit 434) configuring the control unit 43 are respectively functional blocks indicating the functions of the control unit 43. These functional blocks may be software blocks or may be hardware blocks. For example, each of the functional blocks explained above may be one software module implemented by software (including a microprogram) or may be one circuit block on a semiconductor chip (a die). Naturally, each of the functional blocks may be one processor or one integrated circuit. Note that the control unit 43 may be configured in functional units different from the functional blocks explained above. A configuration method for the functional blocks is optional. Operations of the functional blocks are explained below.

### 3. Use Cases

The configuration of the communication system 1 is explained above. Subsequently, specific use cases of the communication system 1 in the present embodiment are explained.

### 3-1. Cloud Game System

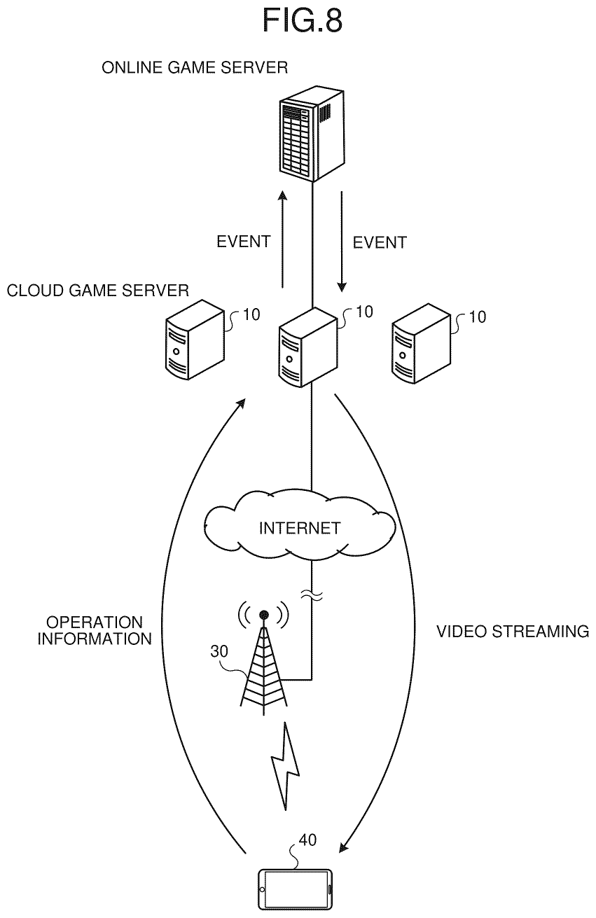

FIG. 8 is a diagram illustrating an example of a use case of the communication system 1. FIG. 8 illustrates a cloud game system as the example of the use case of the communication system 1. The cloud game system includes, for example, an online game server, a cloud game server, a base station, and a terminal device. In the example illustrated in FIG. 8, the cloud game server is the server 10 in the present embodiment. The cloud game server may be a game machine installed in a user's house. The base station is the base station 30 in the present embodiment and the terminal device is the terminal device 40 in the present embodiment. The terminal device may be a smartphone connected to the cloud game server via a network.

In a cloud game, game processing is carried out on the cloud (the cloud game server in the example illustrated in FIG. 8). In an online game of the related art, event information is always transmitted to a server/a terminal device in both uplink and downlink. However, in the case of the cloud game, only operation information is transmitted to the cloud game server in uplink and only a video (video streaming) is transmitted to the terminal device in downlink.

During cloud game play, transmission and reception of game videos and game operation information are executed. During the game play, the user sometimes does not operate a controller (the terminal device in the example illustrated in FIG. 8) for a certain period of time. At this time, there is a possibility that no data is left in the buffer in the terminal device. That is, there is a possibility that the BSR (Buffer status report) is zero even during the game play.

A transmission cycle of the game videos varies depending on a frame rate and is a cycle of approximately 16.6 ms at 60 Hz and a cycle of approximately 8.3 ms at 120 Hz. On the other hand, a transmission cycle of the operation information of the game has various patterns. For example, a cycle of 4.16 ms with approximately four times redundancy can be conceived. In some case, the operation information of the game is more redundant than the game videos. A degree of redundancy required by the frame rate also varies. The frame rate is sometimes variable on an application side. With the Configured Grant, it is difficult to flexibly set the period.

### 3-2. Uplink Video Streaming System

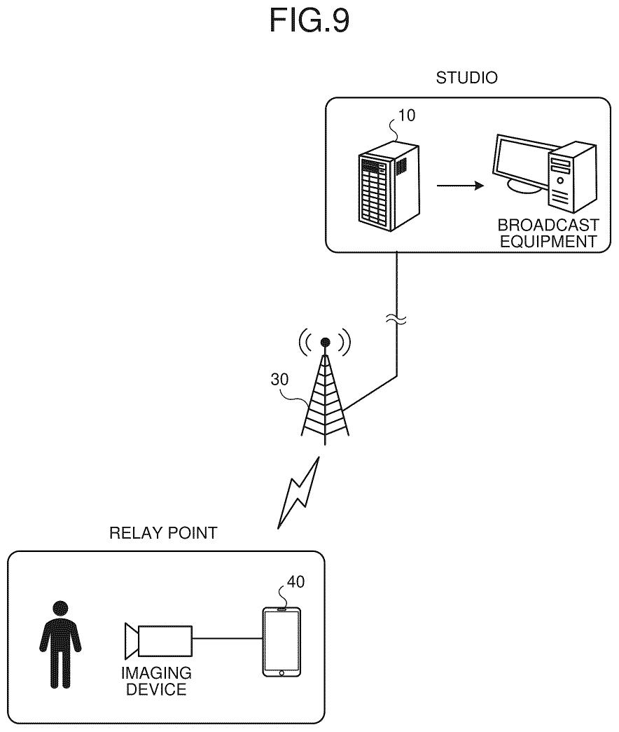

FIG. 9 is a diagram illustrating another example of a use case of the communication system 1. FIG. 9 illustrates an uplink video streaming system as an example of the use case of the communication system 1. The uplink video streaming system includes, for example, a reception server and a broadcast facility located in a studio of a broadcast station, a base station, and an imaging device and a terminal device located at a relay point. In the example illustrated in FIG. 9, the reception server is the server 10 of the present embodiment. The base station is the base station 30 in the present embodiment and the terminal device is the terminal device 40 in the present embodiment.

FIG. 9 illustrates a state in which a video captured at the relay point is immediately uploaded to a studio using a radio network such as 5G. At this time, the communication system may make throughput constant but may reduce the throughput when there is no video change. The throughput can also change depending on an encoder in use. In uplink video streaming, BSR=0 is unlikely, but there can be a case in which transmission of a BSR (Buffer status report) is skipped. After all, with the Configured Grant, the period cannot be flexibly set.

### 4. Operation of the Communication System

The use cases of the communication system 1 are explained above. Subsequently, an operation of the communication system 1 is explained.

### 4-1. First Embodiment

As explained in <1-2-1. Problem 1> above, in the scheme of the related art, when the timing when the terminal device 40 performs the operation concerning mobility and the timing when the terminal device 40 transmits the BSR (Buffer status report) overlap, the transmission of the BSR is canceled/skipped on the terminal device side and the transmission of the UL data is delayed. This is explained with reference to the figures.

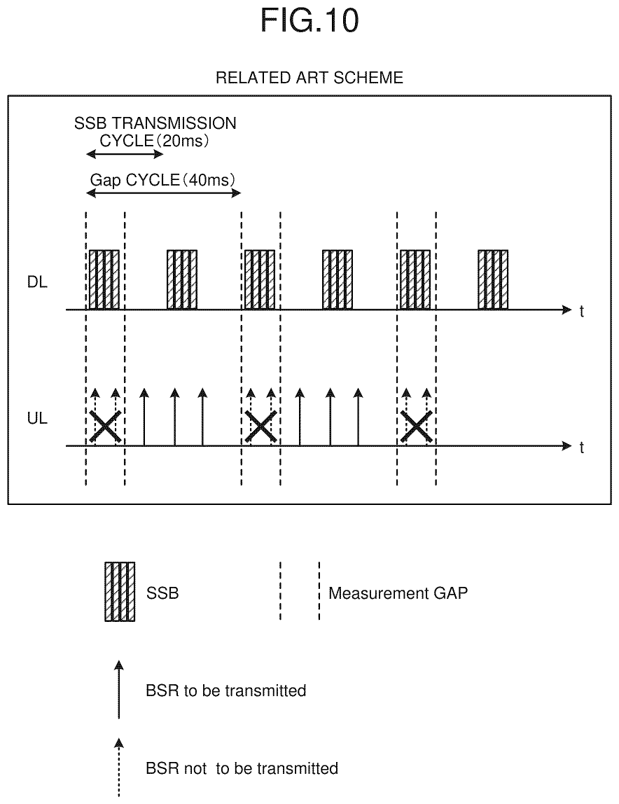

FIG. 10 is a diagram illustrating a BSR transmission operation of the scheme of the related art. In an example illustrated in FIG. 10, an operation concerning mobility is a measurement operation for frequencies (hereinafter also referred to as different frequencies) other than a frequency of a serving cell. A Measurement Gap illustrated in FIG. 10 is a measurement window for the measurement. The measurement operation for the different frequencies is repeated at a constant cycle. An SSB illustrated in FIG. 10 is a synchronization signal block transmitted from the base station at a constant cycle. In the example illustrated in FIG. 10, the SSB transmission cycle is 20 ms and a cycle of the Measurement Gap (hereinafter also referred to as Gap cycle) is 40 ms that is twice the SSB transmission cycle.

The terminal device 40 performs the measurement operation for the different frequencies without transmitting and receiving data during a measurement gap period (hereinafter also referred to as Gap period.). Therefore, as illustrated in FIG. 10, the terminal device 40 cancels/skips transmission of a BSR at timing when measurement timing of the different frequencies and transmission timing of the BSR conflict with each other. When the transmission of the BSR is canceled/skipped, even if UL data is present on the inside of the terminal device 40, a UL scheduling grant is not allocated from the base station 30 to the terminal device 40. As a result, a transmission delay of the UL data occurs.

Therefore, in a first embodiment, when priority of the UL data is high priority, the terminal device 40 transmits a BSR linked with the UL data to the base station preferentially over the operation concerning the mobility even at timing for performing the operation concerning the mobility. The operation concerning mobility may be the measurement operation for the different frequencies, may be beam switching operation, or may be handover.

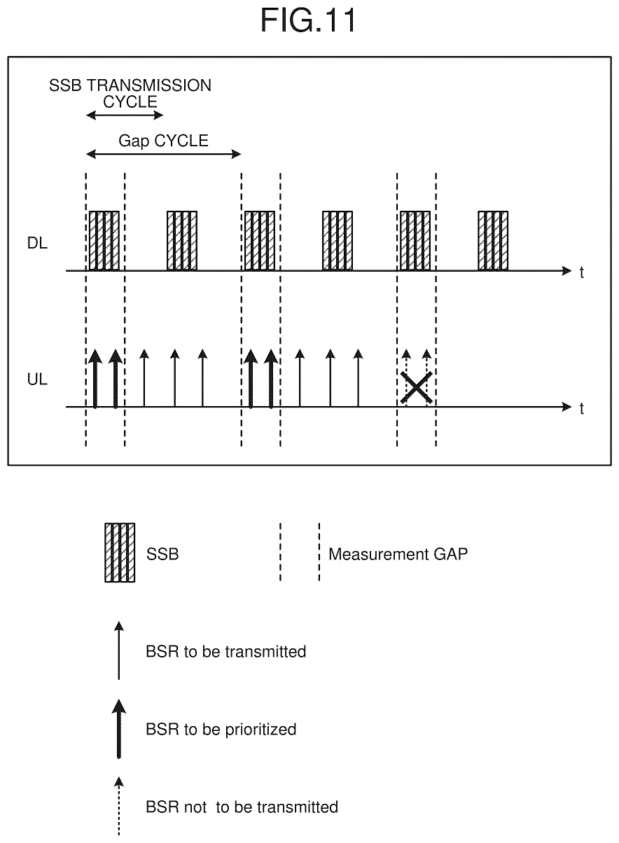

FIG. 11 is a diagram illustrating a BSR transmission operation in the first embodiment. In an example illustrated in FIG. 11, as in the example illustrated in FIG. 10, the operation concerning mobility is the measurement operation for different frequencies. The SSB transmission cycle is, as an example, 20 ms but is not limited to this example. The Gap cycle is, as an example, 40 ms but is not limited to this example. The acquisition unit 431 of the terminal device 40 acquires information concerning transmission target UL data and priority of the UL data. When the priority of the UL data is high priority, the transmission unit 433 of the terminal device 40 performs a transmission operation for a BSR linked with the UL data preferentially over the measurement operation for the different frequencies even during the Gap period. On the other hand, when the priority of the UL data is not high priority, the transmission unit 433 performs the measurement operation for the different frequencies preferentially over the transmission operation for the BSR.

The reception unit 334 of the base station 30 receives the BSR from the terminal device 40. Then, when the BSR is received from the terminal device 40, the transmission unit 333 of the base station 30 transmits a UL scheduling grant corresponding to the BSR to the terminal device 40. The reception unit 434 of the terminal device 40 receives a UL scheduling grant corresponding to the transmitted BSR from the base station 30. The transmission unit 433 of the terminal device 40 transmits the UL data based on the received UL scheduling grant.

Note that the terminal device 40 may perform, based on own determination of the terminal device 40, setting of priority to the UL data. For example, the setting unit 432 of the terminal device 40 sets priority to the UL data based on information concerning a service that has generated the UL data. For example, when the service that has generated the UL data is a service that requires a low delay, such as video streaming distribution or a cloud game, the setting unit 432 of the terminal device 40 sets first priority indicating high priority to the UL data. On the other hand, when the service that has generated the UL data is a service that does not require a low delay, the setting unit 432 sets second priority indicating the normal priority/low priority to the UL data.

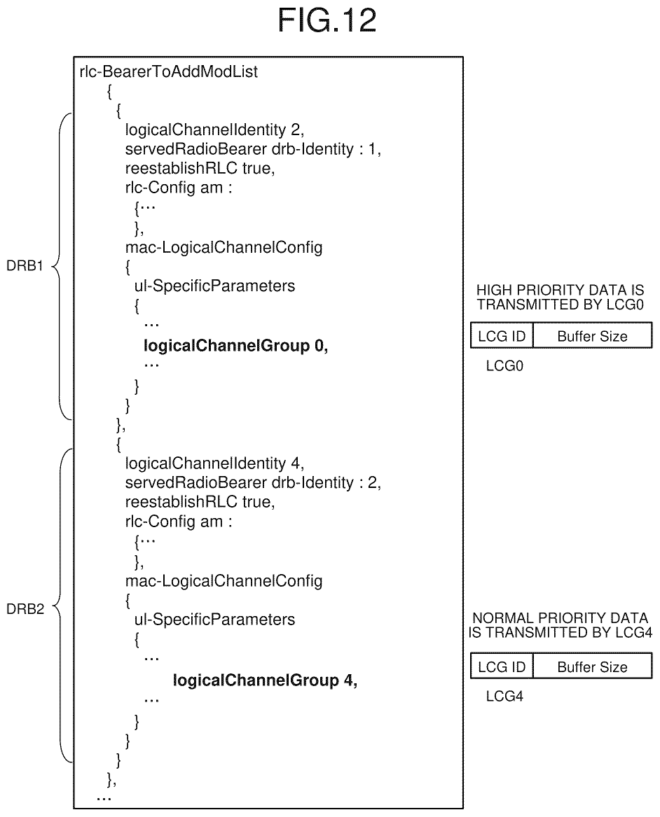

FIG. 12 is a diagram for describing a specific example of the priority setting to the UL data. For example, the terminal device 40 prepares a plurality of DRBs (Data Radio Bearers)/LCGs (Logical Channel Groups) and sets the DRBs/the LCGs separately by priority of the UL data. In the example illustrated in FIG. 12, high priority data is transmitted by LCGO (Logical Channel Group 0) and normal priority data is transmitted by LCG04 (Logical Channel Group 4).

Note that the terminal device 40 may performs the setting of the priority to the UL data based on a notification from an external device. For example, the setting unit 432 of the terminal device 40 may set priority to the UL data based on an instruction from the base station 30 or may set priority to the UL data based on an instruction from the server 10 (for example, a cloud game server) that processes the UL data. At this time, the terminal device 40 may receive a notification concerning the setting of the priority through the MAC CE/RRC reconfiguration/PDCCH of the PDSCH every time the UL data is transmitted.

Even if the priority of the UL data is high priority, the terminal device 40 does not always need to prioritize the BSR transmission. When a predetermined condition is satisfied, the terminal device 40 may execute the operation concerning the mobility preferentially over the transmission of the BSR even if the priority of the UL data is high priority.

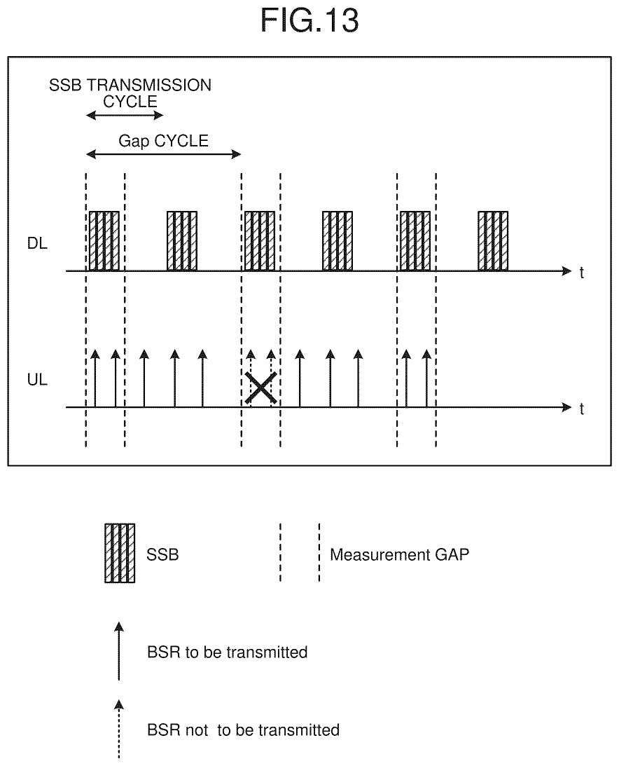

FIG. 13 is a diagram illustrating a modification of the BSR transmission operation in the first embodiment. For example, it is assumed that the operation concerning mobility is the measurement operation for the different frequencies repeatedly executed at a constant cycle (for example, 40 ms). At this time, at timing of a predetermined execution cycle (for example, 80 ms) longer than the constant cycle (for example, 40 ms), even if the priority of the UL data is high priority, the terminal device 40 may execute the measurement operation for the different frequencies preferentially over the transmission of the BSR. That is, the terminal device 40 may relax the number of times of measurement of different frequencies and increase the number of times of transmission of the BSR rather than always prioritizing the BSR transmission. More specifically, when the Gap cycle is set to once in every 40 ms (in the case of MG #0), the terminal device 40 may read the Gap cycle as once in every 80 ms. Note that the base station 30 may notify this rate of the relaxation in advance to the terminal device 40 with RRC reconfiguration or the like. The terminal device 40 may relax the number of times of the measurement of the different frequencies based on this notification.

Note that the operation concerning mobility is not limited to the measurement operation for the different frequencies. For example, the operation concerning mobility may be a beam switching operation or may be handover. In this case, the base station 30/the terminal device 40 may determine, according to whether the quality of a cell beam can be maintained and/or whether throughput necessary to maintain a service can be achieved, which of the BSR transmission and the operation concerning mobility is prioritized.

According to the first embodiment, when the priority of the UL data is high priority, the BSR is transmitted to the base station 30 preferentially over the operation concerning mobility. As a result, since a transmission delay of the high-priority UL data is reduced, the communication system 1 can implement a low-delay system suitable for a use case.

### 4-2. Second Embodiment

As explained in <1-2-1. Problem 1> above, in the scheme of the related art, the transmission of the BSR (Buffer status report) is sometimes canceled/skipped on the terminal device 40 side. In this case, the terminal device 40 has to redo the transmission procedure from the transmission of the scheduling request. When the transmission procedure is redundant, the transmission of the UL data is greatly delayed. In addition, as explained in <1-2-2. Problem 2> above, when it is known that the UL data transmission continuously occurs in video streaming distribution, a game, or the like, the procedure itself of transmitting the BSR and receiving the UL scheduling grant is redundant.

Therefore, in a second embodiment, the terminal device 40 transmits the BSR to the base station 30 through a PUCCH or a UL reference signal (for example, an SRS) in a predetermined state. For example, in the case of a state in which a BSR cannot be transmitted to the base station 30 with a PUSCH because of an operation concerning mobility, the terminal device 40 transmits the BSR to the base station 30 through the PUCCH or the SRS. Alternatively, the transmission unit 433 of the terminal device 40 transmits the BSR to the base station 30 through the PUCCH or the SRS when UL data is continuously generated. For example, the transmission unit 433 of the terminal device 40 transmits the BSR to the base station 30 through the PUCCH or the SRS in the case of a state in which UL data is continuously generated by a cloud game. At this time, the UL data may be operation information of the cloud game.

When transmitting the BSR through the PUCCH, in data transmission executed using the PUCCH for a purpose different from a transmission purpose of the UL data (hereinafter referred to as another purpose), the terminal device 40 may transmit the BSR simultaneously with the data transmission. For example, when transmitting HARQ ACK/NACK or when transmitting a scheduling request for UL data different from the UL data explained above, the terminal device 40 may transmit the BSR simultaneously with the data transmission.

Further, a PUCCH format may be allocated anew exclusively for BSR transmission. For example, a new format exclusive for BSR transmission may be provided in the formats (formats 0 to 4) described in TS38.211 of 3GPP. The terminal device 40 may transmit the BSR by transmitting a PUCCH in the new format.

The transmission of the BSR through the PUCCH may be limited to a case in which a transmission target BSR is a short BSR from the viewpoint of saving the number of bits. The BSR to be transmitted may be a BSR more granular than a normal BSR or may be 1-bit information for notifying only presence or absence of UL data. At this time, the base station 30 may set a table in the terminal device 40 in advance using RRC or a MAC CE. For example, when the BSR is 1-bit information, the base station 30 may set a table indicating that bit #0 is “No data” and bit #1 is D “Data exists” in the terminal device 40 in advance.

When the BSR is transmitted by a UL reference signal (for example, an SRS), a sequence of the UL reference signal may be set as a sequence corresponding to the BSR to enable that the base station 30 to discriminate content of the BSR. For example, a device developer (or the base station 30) sets a plurality of sequence IDs in the terminal device 40. The terminal device 40 and the base station 30 hold setting information for linking the sequence IDs and values of BSRs. The terminal device 40 transmits, to the base station 30, an SRS of a sequence ID corresponding to a value of a BSR desired to be transmitted to enable the base station 30 to discriminate content of the BSR.

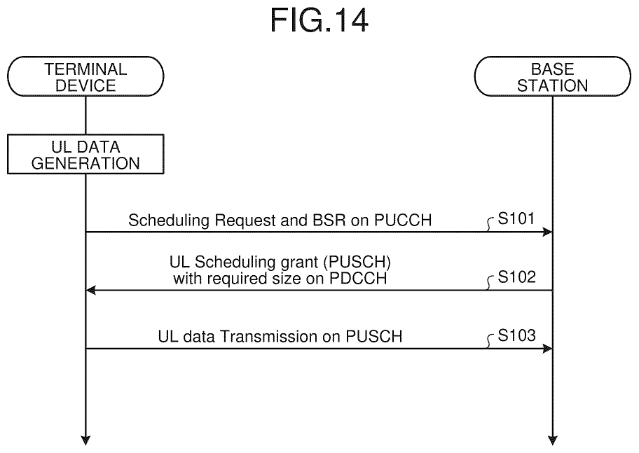

The solution is explained above. Subsequently, a UL data transmission procedure in the second embodiment is explained below. FIG. 14 is a sequence chart illustrating the UL data transmission procedure in the second embodiment.

First, when UL data is generated on the inside of the terminal device 40, the transmission unit 433 of the terminal device 40 transmits a scheduling request to the base station using the PUCCH. At this time, the transmission unit 433 of the terminal device 40 transmits a BSR to the base station 30 together with the scheduling request (step S101). At this time, the scheduling request may be a scheduling request for transmitting UL data different from UL data targeted by the BSR or may be a scheduling request for transmitting the UL data targeted by the BSR.

The reception unit 334 of the base station 30 receives the scheduling request and the BSR. The setting unit 332 of the base station 30 determines an UL scheduling grant having an appropriate size based on the BSR reported from the terminal device 40. Then, the transmission unit 333 of the base station 30 notifies the UL scheduling grant to the terminal device 40 using the PDCCH (step S102).

The transmission unit 433 of the terminal device 40 receives the UL scheduling grant. The transmission unit 433 of the terminal device 40 starts transmission of the UL data according to the received UL scheduling grant (step S103).

According to the second embodiment, since the BSR is transmitted through the PUCCH or the UL reference signal, the terminal device 40 can transmit the BSR to the base station 30 even in a state in which the BSR cannot be transmitted to the base station 30 through the PUSCH for the operation concerning mobility. Since the transmission procedure of the UL data is reduced by using the PUCCH or the SRS, the communication system 1 can realize a low delay even when UL data transmission continuously occurs in the terminal device 40.

### 4-3. Third Embodiment

As explained in <1-2-1. Problem 1> above, in the scheme of the related art, the transmission of the BSR (Buffer status report) is sometimes canceled/skipped on the terminal device 40 side. In this case, the terminal device 40 has to redo the transmission procedure from the transmission of the scheduling request and the transmission of the UL data is delayed. As explained in <1-2-2. Problem 2> above, in the service in which the UL data transmission continuously occurs, such as video streaming distribution or a game, the buffer in the terminal device sometimes instantaneously has no UL data. At this time, when the terminal device reports BSR=0 to the base station, the allocation of the UL scheduling grant from the base station 30 stops. Then, regardless of the fact that the UL data is continuously generated, the terminal device 40 has to redo the transmission of the scheduling request and the transmission of the UL data is delayed.

Therefore, in the second embodiment, even when BSR=0 is reported from the terminal device 40 or no BSR is transmitted from the terminal device 40, the base station 30 determines, according to the application, that the UL data is continuously transmitted and continuously allocates the UL scheduling grant.

More specifically, the base station 30 discriminates whether the terminal device 40 is in a state in which the UL data is continuously generated in the terminal device 40 (hereinafter referred to as UL data continuous occurrence state). Then, when discriminating that the UL data is continuously generated in the terminal device 40, the base station 30 transmits the UL scheduling grant to the terminal device 40 even when the BSR (BSR=0) indicating that there is no UL data in a buffer is received from the terminal device 40 or even when the BSR is not received within a predetermined period from the previous reception of the BSR. The terminal device 40 receives the UL scheduling grant from the base station 30. Then, the terminal device 40 transmits the UL data based on the received UL scheduling grant.

Note that, for example, when receiving, several times, BSR (BSR=0) indicating that there is no UL data in the buffer, the base station 30 may determine that there is actually no UL data and stop the allocation of the UL scheduling grant.

When determining that the terminal device 40 is in the UL data continuous occurrence state, the base station 30 may notify a result of the determination to the terminal device 40. At that time, the terminal device 40 may omit the transmission of the BSR.

The base station 30 may learn a data pattern for each application. The base station 30 may determine, based on a learning result, whether the terminal device 40 is in a continuous transmission state. The base station 30 may synchronize with data to be handled (for example, cooperate with a Time Sensitive Network,) and determine whether the terminal device 40 is in the continuous transmission state.

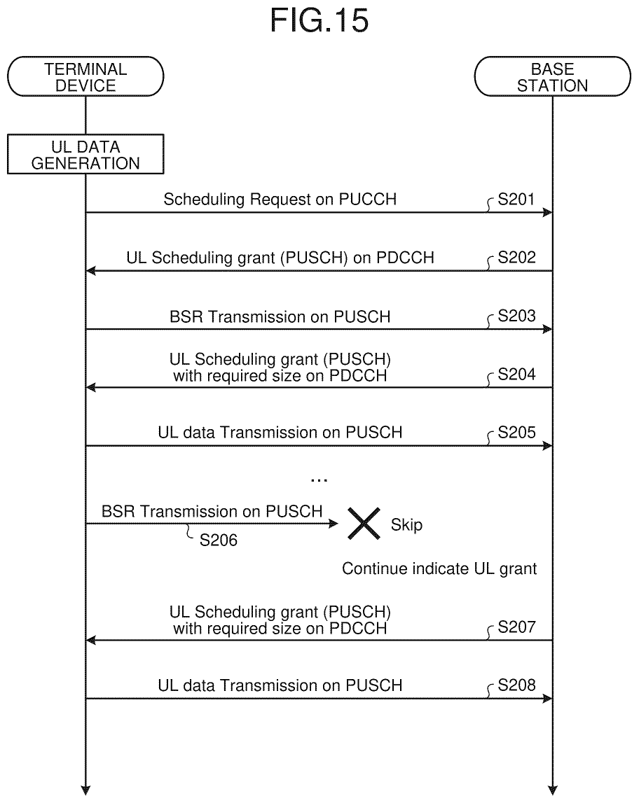

The solution is explained above. Subsequently, a UL data transmission procedure in a third embodiment is explained. FIG. 15 is a sequence chart illustrating the UL data transmission procedure in the third embodiment. Note that in an example illustrated in FIG. 15, it is assumed that the terminal device 40 is in the state in which UL data is continuously generated (the UL data continuous generation state) and the base station 30 discriminates that the terminal device 40 is in the UL data continuous generation.

First, when UL data is generated in the terminal device 40, the terminal device 40 transmits a scheduling request to the base station 30 through a PUCCH (step S201). After receiving the scheduling request, the base station 30 notifies a UL scheduling grant to the terminal device 40 through a PDCCH (step S202). The terminal device 40 transmits a BSR to the base station 30 according to the UL scheduling grant (step S203). The base station 30 determines, based on the BSR reported from the terminal device 40, an UL scheduling grant having an appropriate size. Then, the base station notifies the UL scheduling grant to the terminal device 40 through the PDCCH (step S204). The terminal device 40 starts transmission of the UL data according to the instructed UL scheduling grant (step S205).

When the transmission of the BSR from the terminal device 40 is interrupted (step S206), the base station 30 continues the transmission of the UL scheduling grant (step S207). At this time, the base station 30 may determine the UL scheduling grant based on one or a plurality of BSRs previously received from the terminal device 40 (for example, an immediately precedingly received BSR). The terminal device 40 transmits the UL data according to the instructed UL scheduling grant (step S208).

According to the third embodiment, when it is discriminated that the terminal device 40 is in the state in which the UL data is continuously generated, the base station 30 transmits the UL scheduling grant to the terminal device 40 even when the BSR indicating that there is no UL data in the buffer is received from the terminal device 40 or even when the BSR is not received. As a result, since the transmission interruption of the UL data is reduced, the communication system 1 can realize a low delay.

### 4-4. Fourth Embodiment

As explained in <1-2-2. Problem 2> above, in the service in which the UL data transmission continuously occurs, such as video streaming distribution or a game, the buffer in the terminal device sometimes instantaneously has no UL data. At this time, when the terminal device reports, to the base station, BSR (BSR=0) indicating that there is no UL data in the buffer, the allocation of the UL scheduling grant from the base station 30 is stopped.

Then, regardless of the fact that the UL data is continuously generated, the terminal device 40 has to redo the transmission of the scheduling request and the transmission of the UL data is delayed.

Therefore, in a fourth embodiment, even when no UL data is left in a buffer, the terminal device 40 transmits, to the base station 30, a BSR indicating that there is UL data in the buffer. For example, even when no UL data is left in the buffer in the terminal device 40, the terminal device 40 generates ping-like dummy data in the terminal device 40 and transmits, to the base station 30, a BSR (BSR>0) indicating that there is UL data in the buffer. Note that the terminal device 40 may execute this processing only at the time of a state in which UL data transmission continuously occurs. Thereafter, when receiving a UL scheduling grant corresponding to the BSR from the base station 30, the terminal device 40 transmits the UL data based on the UL scheduling grant.

Note that the terminal device 40 may notify the base station 30 of an instruction (Indication) for requesting the UL scheduling grant instead of the BSR.

According to the fourth embodiment, even when no UL data is left in the buffer, the terminal device 40 can obtain the UL scheduling grant from the base station 30. As a result, since the transmission interruption of the UL data is reduced, the communication system 1 can realize a low delay.

### 5. Modifications

The embodiments explained above indicate examples and various changes and applications of the embodiments are possible.

For example, a control device that controls the server 10, the management device 20, the base station 30, and the terminal device 40 of the present embodiments may be implemented by a dedicated computer system or may be implemented by a general-purpose computer system.

For example, a communication program for executing the operation explained above is distributed by being stored in a computer-readable recording medium such as an optical disk, a semiconductor memory, a magnetic tape, or a flexible disk. Then, for example, the program is installed in a computer and the control device is configured by executing the processing explained above. At this time, the control device may be a device (for example, a personal computer) on the outside of the management device 20, the base station 30, and the terminal device 40. The control device may be a device (for example, the control unit 13, the control unit 23, the control unit 33, and the control unit 43) on the inside of the server 10, the management device 20, the base station 30, and the terminal device 40.

The communication program explained above may be stored in a disk device included in a server device on a network such as the Internet such that the communication program can be downloaded to a computer. The functions explained above may be implemented by cooperation of an OS (Operating System) and application software. In this case, a portion other than the OS may be stored in a medium and distributed or the portion other than the OS may be stored in the server device such that the portion can be downloaded to the computer.

Among the kinds of processing explained in the embodiments, all or a part of the processing explained as being automatically performed can be manually performed or all or a part of the processing explained as being manually performed can be automatically performed by a publicly-known method. Besides, the processing procedures, the specific names, and the information including the various data and parameters explained in the document and illustrated in the drawings can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like. Note that this configuration by the distribution and the integration may be dynamically performed.

The embodiments explained above can be combined as appropriate in a range for not causing processing contents to contradict one another. The order of the steps illustrated in the flowcharts of the embodiments explained above can be changed as appropriate.

For example, the present embodiments can be implemented as any component configuring a device or a system, for example, a processor functioning as a system LSI (Large Scale Integration) or the like, a module that uses a plurality of processors or the like, a unit that uses a plurality of modules or the like, or a set obtained by further adding other functions to the unit (that is, a component as a part of the device).

Note that, in the present embodiments, the system means a set of a plurality of components (devices, modules (parts), and the like). It does not matter whether all the components are present in the same housing. Therefore, both of a plurality of devices housed in separate housings and connected via a network and one device in which a plurality of modules is housed in one housing are systems.

For example, the present embodiments can adopt a configuration of cloud computing in which one function is shared and processed by a plurality of devices in cooperation via a network.

### 6. Conclusion

As explained above, when the priority of the UL data is high priority, the terminal device 40 according to the present embodiments transmits the BSR linked with the UL data to the base station preferentially over the operation concerning mobility even at the timing of performing the operation concerning mobility.

Accordingly, since a transmission delay of the high-priority UL data is reduced, the communication system 1 can implement a low-delay system suitable for a use case.

The terminal device 40 in the present embodiments transmits the BSR to the base station 30 through the PUCCH or the UL reference signal in a predetermined state. For example, in the case of a state in which a BSR cannot be transmitted to the base station 30 with a PUSCH because of an operation concerning mobility, the terminal device 40 transmits the BSR to the base station 30 through the PUCCH or the SRS. Alternatively, the transmission unit 433 of the terminal device 40 transmits the BSR to the base station 30 through the PUCCH or the SRS when UL data is continuously generated.

Accordingly, the terminal device 40 can transmit the BSR to the base station 30 even in the case of the state in which the BSR cannot be transmitted to the base station 30 through the PUSCH because of the operation concerning mobility. Since the transmission procedure of the UL data is reduced by using the PUCCH or the SRS, the communication system 1 can realize a low delay even when UL data transmission continuously occurs in the terminal device 40.

When it is discriminated that the terminal device 40 is in a state in which the UL data is continuously generated in the terminal device 40, the base station 30 in the present embodiments transmits the UL scheduling grant to the terminal device 40 even when the BSR indicating that there is no UL data in the buffer is received from the terminal device 40 or even when the BSR is not received within a predetermined period from the last reception of the BSR.

Accordingly, since transmission interruption of the UL data in the case in which the UL data is continuously generated in the terminal device 40 is reduced, the communication system 1 can realize a low delay.

Even when no UL data is left in the buffer, the terminal device 40 in the present embodiments transmits, to the base station 30, a BSR indicating that there is UL data in the buffer.

Accordingly, since the transmission interruption of the UL data is reduced, the communication system 1 can realize a low delay.

Although the embodiments of the present disclosure are explained above, the technical scope of the present disclosure is not limited to the embodiments per se. Various changes can be made without departing from the gist of the present disclosure. Components in different embodiments and modifications may be combined as appropriate.

The effects in the embodiments described in this specification are only illustrations and are not limited. Other effects may be present.

Note that the present technique can also take the following configurations.

(1)

A communication device comprising:
a transmission unit that, when priority of uplink data is predetermined priority, preferentially over an operation concerning mobility, transmits a buffer status report linked with the uplink data to a base station; and
a reception unit that receives, from the base station, an uplink scheduling grant corresponding to the buffer status report.
   (2)

The communication device according to (1), wherein
the operation concerning mobility includes a measurement operation for a frequency other than a frequency of a serving cell.
   (3)

The communication device according to (1) or (2), wherein
the operation concerning mobility includes a beam switching operation.
   (4)

The communication device according to (1) or (2), wherein
the operation concerning mobility includes handover.
   (5)

The communication device according to any one of (1) to (4), comprising
a setting unit that sets the priority to the uplink data based on information concerning a service that has generated the uplink data.
   (6)

The communication device according to any one of (1) to (4), comprising a setting unit that sets the priority to the uplink data based on an instruction from an external server that processes the uplink data.

(7)

The communication device according to any one of (1) to (6), wherein,
when a predetermined condition is satisfied, the transmission unit executes the operation concerning the mobility preferentially over the transmission of the buffer status report even if the priority of the uplink data is the predetermined priority.
   (8)

The communication device according to (7), wherein
the operation concerning mobility is a measurement operation for a frequency other than a frequency of a serving cell,
the measurement operation is repeatedly executed at a constant cycle, and
at timing of a predetermined execution cycle longer than the constant cycle, the transmission unit executes the measurement operation preferentially over the transmission of the buffer status report even if the priority of the uplink data is the predetermined priority.
   (9)

A communication device comprising:
a reception unit that receives, from a terminal device configured to transmit a buffer status report linked with the uplink data preferentially over an operation concerning mobility when priority of uplink data is predetermined priority, the buffer status report; and
a transmission unit that, when receiving the buffer status report, transmits, to the terminal device, an uplink scheduling grant corresponding to the buffer status report.
   (10)

A communication method comprising:
when priority of uplink data is predetermined priority, preferentially over an operation concerning mobility, transmitting a buffer status report linked with the uplink data to a base station; and
receiving, from the base station, an uplink scheduling grant corresponding to the buffer status report.
   (11)

A communication method comprising:
receiving, from a terminal device configured to transmit a buffer status report linked with the uplink data preferentially over an operation concerning mobility when priority of uplink data is predetermined priority, the buffer status report; and
when receiving the buffer status report, transmitting, to the terminal device, an uplink scheduling grant corresponding to the buffer status report.
   (12)

A communication device comprising:
a transmission unit that, in a case of a predetermined state, transmits a buffer status report linked with uplink data to a base station through an uplink control channel or an uplink reference signal; and
a reception unit that receives an uplink scheduling grant corresponding to the buffer status report from the base station.
   (13)

The communication device according to (12), wherein,
in a case of a state in which the buffer status report linked with the uplink data cannot be transmitted to the base station through an uplink shared channel because of an operation concerning mobility, the transmission unit transmits the buffer status report linked with the uplink data to the base station through an uplink control channel or an uplink reference signal.
   (14)

The communication device according to (12) or (13), wherein,
in a case of a state in which the uplink data is continuously generated, the transmission unit transmits the buffer status report linked with the uplink data to the base station through an uplink control channel or an uplink reference signal.
   (15)

The communication device according to (14), wherein
the uplink data is operation information of a cloud game.
   (16)

The communication device according to any one of (12) to (15), wherein,
in data transmission executed using the uplink control channel for a purpose different from a transmission purpose of the uplink data, the transmission unit transmits the buffer status report using the uplink control channel simultaneously with the data transmission.
   (17)

The communication device according to any one of (12) to (15), wherein
the transmission unit sets a sequence of the uplink reference signal as a sequence corresponding to the buffer status report to enable the base station to discriminate content of the buffer status report.
   (18)

A communication device comprising:
a reception unit that, receives, from a terminal device configured to transmit a buffer status report linked with uplink data to a base station through an uplink control channel or an uplink reference signal in a case of a predetermined state, the buffer status report; and
a transmission unit that, when receiving the buffer status report, transmits an uplink scheduling grant corresponding to the buffer status report to the terminal device.
   (19)

A communication method comprising:
in a case of a predetermined state, transmitting a buffer status report linked with uplink data to a base station through an uplink control channel or an uplink reference signal; and
receiving an uplink scheduling grant corresponding to the buffer status report from the base station.
   (20)

A communication method comprising:
receiving, from a terminal device configured to transmit a buffer status report linked with uplink data to a base station through an uplink control channel or an uplink reference signal in a case of a predetermined state, the buffer status report; and
when receiving the buffer status report, transmitting an uplink scheduling grant corresponding to the buffer status report to the terminal device.
   (21)

A communication device that communicates with a base station, the communication device including
a reception unit that, when it is discriminated that the communication device is in a state in which uplink data is continuously generated in the communication device, receives an uplink scheduling grant corresponding to the continuously generated uplink data from the base station that transmits the uplink scheduling grant to the communication device even when receiving, from the communication device, a buffer status report indicating that there is no data in a buffer or even when the buffer status report is not transmitted from the communication device.
   (22)

A communication device including
a transmission unit that, when it is discriminated that the terminal device is in a state in which uplink data is continuously generated in the terminal device, transmits an uplink scheduling grant corresponding to the continuously generated uplink data to the terminal device even when receiving, from the terminal device, a buffer status report indicating that there is no data in a buffer or even when the buffer status report is not transmitted from the terminal device.
   (23)

A communication method executed by a communication device that communicates with a base station, the communication method including,
when it is discriminated that the communication device is in a state in which uplink data is continuously generated in the communication device, receiving an uplink scheduling grant corresponding to the continuously generated uplink data from the base station that transmits the uplink scheduling grant to the communication device even when receiving, from the communication device, a buffer status report indicating that there is no data in a buffer or even when the buffer status report is not transmitted from the communication device.
   (24)

A communication method including,
when it is discriminated that a terminal device is in a state in which uplink data is continuously generated in the terminal device, transmitting an uplink scheduling grant corresponding to the continuously generated uplink data to the terminal device even when receiving, from the terminal device, a buffer status report indicating that there is no data in a buffer or even when the buffer status report is not transmitted from the terminal device.
   (25)

A communication device including:
a transmission unit that, even when no uplink data is left in a buffer, transmits, to a base station, a buffer status report indicating that there is uplink data in the buffer; and
a reception unit that receives, from the base station, an uplink scheduling grant corresponding to the buffer status report.
   (26)

A communication device including:
a reception unit that, even when no uplink data is left in a buffer, receives, from a terminal device configured to transmit, to a base station, a buffer status report indicating that there is uplink data in the buffer, the buffer status report; and
a transmission unit that, when receiving the buffer status report, transmits an uplink scheduling grant corresponding to the buffer status report to the terminal device.
   (27)

A communication method including:
even when no uplink data is left in a buffer, transmitting, to a base station, a buffer status report indicating that there is uplink data in the buffer; and
receiving, from the base station, an uplink scheduling grant corresponding to the buffer status report.
   (28)

A communication method including:
even when no uplink data is left in a buffer, receiving, from a terminal device configured to transmit, to a base station, a buffer status report indicating that there is uplink data in the buffer, the buffer status report; and
when receiving the buffer status report, transmitting an uplink scheduling grant corresponding to the buffer status report to the terminal device.

### REFERENCE SIGNS LIST

1 COMMUNICATION SYSTEM
10 SERVER
20 MANAGEMENT DEVICE
30 BASE STATION
40 TERMINAL DEVICE
11, 21 COMMUNICATION UNIT
31, 41 WIRELESS COMMUNICATION UNIT
12, 22, 32, 42 STORAGE UNIT
13, 23, 33, 43 CONTROL UNIT
311, 411 TRANSMISSION PROCESSING UNIT
312, 412 RECEPTION PROCESSING UNIT
313, 413 ANTENNA
331, 431 ACQUISITION UNIT
332, 432 SETTING UNIT
333, 433 TRANSMISSION UNIT
334, 434 RECEPTION UNIT

1. A communication device comprising:
a transmission unit that, when priority of uplink data is predetermined priority, preferentially over an operation concerning mobility, transmits a buffer status report linked with the uplink data to a base station; and
a reception unit that receives, from the base station, an uplink scheduling grant corresponding to the buffer status report.

2. The communication device according to claim 1, wherein
the operation concerning mobility includes a measurement operation for a frequency other than a frequency of a serving cell.

3. The communication device according to claim 1, wherein
the operation concerning mobility includes a beam switching operation.

4. The communication device according to claim 1, wherein
the operation concerning mobility includes handover.

5. The communication device according to claim 1, comprising
a setting unit that sets the priority to the uplink data based on information concerning a service that has generated the uplink data.

6. The communication device according to claim 1, comprising a setting unit that sets the priority to the uplink data based on an instruction from an external server that processes the uplink data.

7. The communication device according to claim 1, wherein,
when a predetermined condition is satisfied, the transmission unit executes the operation concerning the mobility preferentially over the transmission of the buffer status report even if the priority of the uplink data is the predetermined priority.

8. The communication device according to claim 7, wherein
the operation concerning mobility is a measurement operation for a frequency other than a frequency of a serving cell,
the measurement operation is repeatedly executed at a constant cycle, and
at timing of a predetermined execution cycle longer than the constant cycle, the transmission unit executes the measurement operation preferentially over the transmission of the buffer status report even if the priority of the uplink data is the predetermined priority.

9. A communication device comprising:
a reception unit that receives, from a terminal device configured to transmit a buffer status report linked with the uplink data preferentially over an operation concerning mobility when priority of uplink data is predetermined priority, the buffer status report; and
a transmission unit that, when receiving the buffer status report, transmits, to the terminal device, an uplink scheduling grant corresponding to the buffer status report.

10. A communication method comprising:
when priority of uplink data is predetermined priority, preferentially over an operation concerning mobility, transmitting a buffer status report linked with the uplink data to a base station; and
receiving, from the base station, an uplink scheduling grant corresponding to the buffer status report.

11. A communication method comprising:
receiving, from a terminal device configured to transmit a buffer status report linked with the uplink data preferentially over an operation concerning mobility when priority of uplink data is predetermined priority, the buffer status report; and
when receiving the buffer status report, transmitting, to the terminal device, an uplink scheduling grant corresponding to the buffer status report.

12. A communication device comprising:
a transmission unit that, in a case of a predetermined state, transmits a buffer status report linked with uplink data to a base station through an uplink control channel or an uplink reference signal; and
a reception unit that receives an uplink scheduling grant corresponding to the buffer status report from the base station.

13. The communication device according to claim 12, wherein,
in a case of a state in which the buffer status report linked with the uplink data cannot be transmitted to the base station through an uplink shared channel because of an operation concerning mobility, the transmission unit transmits the buffer status report linked with the uplink data to the base station through an uplink control channel or an uplink reference signal.

14. The communication device according to claim 12, wherein,
in a case of a state in which the uplink data is continuously generated, the transmission unit transmits the buffer status report linked with the uplink data to the base station through an uplink control channel or an uplink reference signal.

15. The communication device according to claim 14, wherein
the uplink data is operation information of a cloud game.

16. The communication device according to claim 12, wherein,
in data transmission executed using the uplink control channel for a purpose different from a transmission purpose of the uplink data, the transmission unit transmits the buffer status report using the uplink control channel simultaneously with the data transmission.

17. The communication device according to claim 12, wherein
the transmission unit sets a sequence of the uplink reference signal as a sequence corresponding to the buffer status report to enable the base station to discriminate content of the buffer status report.

18. A communication device comprising:
a reception unit that, receives, from a terminal device configured to transmit a buffer status report linked with uplink data to a base station through an uplink control channel or an uplink reference signal in a case of a predetermined state, the buffer status report; and
a transmission unit that, when receiving the buffer status report, transmits an uplink scheduling grant corresponding to the buffer status report to the terminal device.

19. A communication method comprising:
in a case of a predetermined state, transmitting a buffer status report linked with uplink data to a base station through an uplink control channel or an uplink reference signal; and
receiving an uplink scheduling grant corresponding to the buffer status report from the base station.

20. A communication method comprising:
receiving, from a terminal device configured to transmit a buffer status report linked with uplink data to a base station through an uplink control channel or an uplink reference signal in a case of a predetermined state, the buffer status report; and
when receiving the buffer status report, transmitting an uplink scheduling grant corresponding to the buffer status report to the terminal device.
